(19) United States
(12) Patent Application Publication
(10) Pub. No.: US 2026/0060485 A1
(43) Pub. Date: Mar. 5, 2026

(54) WIPE HANDLING DEVICE

(71) Applicant: BLUME TECH INC., Atherton, CA (US)

(72) Inventors: Andreas Fatschel, San Francisco, CA (US); Andrew Rauch, San Francisco, CA (US); Yulian Bagirov, Middletown, RI (US); Billy Boucuvalas, Pittsburgh, PA (US); Braedon Salz, San Francisco, CA (US); Casey Fukunaga, San Diego, CA (US)

(21) Appl. No.: 19/315,822

(22) Filed: Sep. 1, 2025

Related U.S. Application Data
(60) Provisional application No. 63/690,126, filed on Sep. 3, 2024.

(51) Int. Cl. A47K 10/38; A47K 10/32; B65D 43/16; B65D 83/08; C02F 1/461; C02F 1/467

(52) U.S. Cl. CPC A47K 10/3827; B65D 43/166; B65D 83/0805; B65D 83/0894; C02F 1/46104; C02F 1/4674; A47K 2010/3286; A47K 2010/389; C02F 2201/46135; C02F 2201/4614; C02F 2201/4618; C02F 2209/42; C02F 2303/04

(57) ABSTRACT

Embodiments of the present disclosure disclose a wipe handling device. The wipe handling device includes a container and a wipe-infusing unit. The container includes one or more chambers. The wipe-infusing unit is operably coupled to the one or more chambers. The one or more chambers are configured to accommodate at least one wipe and a wipe solution. The wipe-infusing unit receives the at least one wipe and the wipe solution. The wipe-infusing unit is configured to infuse the wipe solution into the at least one wipe at a predetermined concentration, thereby forming at least one infused wipe.

### TECHNICAL FIELD

The present disclosure relates to a field of chemical cleaning and disinfecting, and, more particularly, to a wipe handling device configured to infuse wipes with hypochlorous acid (HOCl), and to store and dispense the infused wipes for use in cleaning, sanitizing, or disinfecting applications.

### BACKGROUND

Disinfecting wipes offer a convenient solution for removing dirt, grime, and other contaminants, while also serving to eliminate viruses, bacteria, and fungi across a wide range of environments. Conventional cleaning wipes often utilize various active chemical agents to achieve both cleaning and disinfecting functions. However, many of these chemical agents present potential hazards to human health upon exposure. The use of electrical energy to produce chemical cleaning or disinfecting solutions, such as through electrolysis, is well established. In many such systems, semi-permeable membranes are employed to physically separate the anode and cathode compartments of an electrolytic cell while allowing selective ion transfer between the two electrodes. This configuration enables the completion of an electrical circuit necessary for electrochemical reactions, while preventing undesirable mixing of generated products.

Conventional techniques that utilize this chemistry typically produce disinfecting solutions in dedicated volumetric systems. Once generated, the solution must be transferred into the final delivery format, such as pre-moistened wipes or dispensing containers. This added step introduces increased manufacturing complexity and demands additional production resources, including time, labor, and equipment, thereby reducing overall efficiency.

Many disinfecting wipes and cleaning products utilize chemical agents that present varying degrees of health and environmental risk. Alcohol-based solutions, while effective antimicrobial agents, are highly flammable and may irritate the skin and respiratory system. Quaternary ammonium compounds (quats) have been linked to respiratory and dermal irritation, potential neurodevelopmental effects, and environmental persistence. Chlorine-based disinfectants such as sodium hypochlorite are corrosive and pose hazards to both human health and ecological systems. Hydrogen peroxide, though commonly used, can cause irritation and presents stability challenges. Phenolic compounds are considered toxic and environmentally persistent. Other commonly used disinfectants, including sodium dichloroisocyanurate and peracetic acid, are known to be corrosive and present inhalation risks. Iodophors may lead to irritation, discoloration of surfaces, and toxicity with repeated exposure. As a result, proper handling, storage, and application of these substances are essential to ensure user safety and minimize adverse effects.

Although safer and more environmentally friendly disinfectants are known, their widespread adoption has been limited due to drawbacks such as unpleasant odor, reduced antimicrobial performance, and short shelf life. Hypochlorous acid (HOCl) is one such compound, recognized for its strong disinfecting and cleaning properties, as well as its safety for human and environmental contact. However, HOCl is typically produced through electrolysis and is inherently unstable, gradually degrading back into saline solution over time. This instability limits its shelf life, complicates transportation, and contributes to higher production costs compared to conventional disinfectants.

To address these challenges, some systems have been developed to generate HOCl on-site from saltwater via electrolysis, enabling point-of-use production and reducing logistics costs. However, such systems are generally not optimized for use with wipe-based products and often lack user-friendliness. These devices may require significant time to generate the solution, demand user supervision during operation, and involve active monitoring of the chemical's remaining efficacy. Meanwhile, disinfecting wipes remain among the most convenient and widely used cleaning solutions due to their ease of use and pre-packaged format. The instability and handling requirements of HOCl, however, have made the development of affordable HOCl-infused wipes particularly challenging.

Conventional disinfectant products often present safety concerns for children and pets, necessitating secure storage to prevent accidental exposure. In contrast, hypochlorous acid exhibits a favorable safety profile, being non-irritating to skin, eyes, and respiratory tissues. Accordingly, a wipe product infused with hypochlorous acid can be safely used and stored in environments accessible to children and pets, such as homes and classrooms, without requiring special containment measures. This safety advantage enhances the convenience and practicality of the product for everyday use.

Therefore, there is a need for a wipe handling device that enables on-demand infusion of hypochlorous acid into wipes, overcoming the aforementioned deficiencies while providing additional technical advantages.

### SUMMARY

Various embodiments of the present disclosure provide a wipe handling device for storing, infusing, and dispensing wipes.

In an embodiment, a wipe handling device is disclosed. The wipe handling device includes a container and a wipe-infusing unit. The container includes having one or more chambers. The wipe-infusing unit is operably coupled to the one or more chambers. The one or more chambers are configured to accommodate at least one wipe and a wipe solution. The wipe-infusing unit receives the at least one wipe and the wipe solution. The wipe-infusing unit is configured to infuse the wipe solution into the at least one wipe at a predetermined concentration, thereby forming at least one infused wipe.

### BRIEF DESCRIPTION OF THE FIGURES

The following detailed description of illustrative embodiments is better understood when read in conjunction with the appended drawings. To illustrate the present disclosure, exemplary constructions of the disclosure are shown in the drawings. However, the present disclosure is not limited to a specific device, or a tool and instrumentalities disclosed herein. Moreover, those in the art will understand that the drawings are not to scale.

FIGS. 1A and 1B illustrate perspective views of a wipe handling device, in accordance with at least some embodiments of the present disclosure;

FIG. 2A illustrates a perspective view of a top portion of the wipe handling device with a lid in an openable position, in accordance with an embodiment of the present disclosure;

FIG. 2B illustrates a front view of the top portion of the wipe handling device with the lid in the openable position and without the covering member, in accordance with an embodiment of the present disclosure;

FIG. 2C illustrates a perspective view of the top portion of the wipe handling device with the lid in the openable position and without the covering member, in accordance with an embodiment of the present disclosure;

FIG. 3A illustrates an exploded view of a wipe handling device 300, in accordance with an embodiment of the present disclosure;

FIG. 3B illustrates a perspective view of a first chamber of the wipe handling device in a closed state, in accordance with an embodiment of the present disclosure;

FIGS. 3C and 3D illustrate perspective views of the first chamber in an open state, in accordance with an embodiment of the present disclosure;

FIG. 3E illustrates a bottom view of the first chamber in the closed state, in accordance with an embodiment of the present disclosure;

FIGS. 3F and 3G illustrate front views of the first chamber in the closed state, in accordance with an embodiment of the present disclosure;

FIGS. 3H and 3I depict schematic representations of a second chamber of the wipe handling device, in accordance with an embodiment of the present disclosure;

FIG. 3J illustrates a frontview of a wipe-infusing unit of the wipe handling device, in accordance with an embodiment of the present disclosure;

FIG. 3K illustrates a perspective view of a first extreme position of a user-operable adjustment actuator of the wipe-infusing unit, in accordance with an embodiment of the present disclosure;

FIG. 3L illustrates a perspective view of a second extreme position of the user-operable adjustment actuator of the wipe-infusing unit, in accordance with an embodiment of the present disclosure;

FIG. 3M illustrates a sectional front view of the user-operable adjustment actuator in the first extreme position, in accordance with an embodiment of the present disclosure;

FIG. 3N illustrates a sectional perspective view of the user-operable adjustment actuator in the first extreme position, in accordance with an embodiment of the present disclosure;

FIG. 3O illustrates a sectional front view of the user-operable adjustment actuator in the second extreme position, in accordance with an embodiment of the present disclosure;

FIG. 3P illustrates a sectional exploded view of the user-operable adjustment actuator in the second extreme position, in accordance with an embodiment of the present disclosure;

FIG. 4 shows a block diagram representation of an electrical circuit system 400 electrically coupled to an electrolysis unit, in accordance with an embodiment of the present disclosure;

FIG. 5 depicts an illustrative flow diagram of a method for generating a predetermined amount of HOCl solution within the electrical circuit system, in accordance with an embodiment of the present disclosure;

FIG. 6 shows a block diagram representation of an electrical circuit system electrically coupled to the electrolysis unit, in accordance with another embodiment of the present disclosure;

FIG. 7 illustrates various waveforms generated while operating the electrical circuit system, in accordance with an embodiment of the present disclosure;

FIG. 8 illustrates the fundamental timing parameters associated with the pulse waveforms, in accordance with an embodiment of the present disclosure;

FIG. 9 shows a block diagram representation of an electrical circuit system electrically coupled to the electrolysis unit, in accordance with another embodiment of the present disclosure;

FIG. 10 illustrates various exemplary waveforms that may be generated using a switching configuration of H-bridge, in accordance with an embodiment of the present disclosure;

FIG. 11 shows a block diagram representation of an electrical circuit system electrically coupled to the electrolysis unit, in accordance with another embodiment of the present disclosure;

FIG. 12 illustrates an exemplary configuration of electrodes employed for the generation of HOCl, in accordance with an embodiment of the present disclosure;

FIG. 13 illustrates an exemplary configuration of electrodes employed for the generation of HOCl, in accordance with another embodiment of the present disclosure;

FIG. 14 illustrates an exemplary configuration of electrodes employed for the generation of HOCl, in accordance with another embodiment of the present disclosure;

FIG. 15 illustrates an exemplary configuration configured to enhance fluid dynamics within the electrolyte solution during hypochlorous acid generation, in accordance with another embodiment of the present disclosure;

FIG. 16 shows a block diagram representation of an electrical circuit system electrically coupled to the electrolysis unit, in accordance with another embodiment of the present disclosure;

FIG. 17 illustrates an exemplary configuration of slidable movement of a wipe relative to one or more anode electrodes and one or more cathode electrodes, in accordance with an embodiment of the present disclosure;

FIG. 18 illustrates a perspective view of an electrode and wipe activation system, in accordance with an embodiment of the present disclosure;

FIG. 19 illustrates an exemplary block diagram outlining a method for automatically monitoring the availability of both wipes and hypochlorous acid solution within the wipe handling device, in accordance with an embodiment of the present disclosure;

FIG. 20 illustrates an exemplary block diagram depicting a method for user interaction with the wipe handling device, in accordance with an embodiment of the present disclosure;

FIG. 21 illustrates a perspective view of a wipe handling device, in accordance with another embodiment of the present disclosure;

FIG. 22 illustrates a perspective view of a wipe handling device, in accordance with another embodiment of the present disclosure;

FIG. 23 illustrates a schematic representation of a wipe handling device, in accordance with another embodiment of the present disclosure;

FIG. 24 illustrates an exemplary method for a user to replenish the wipe handling device, in accordance with an embodiment of the present disclosure;

FIG. 25 illustrates a schematic representation of a fluid circulation mechanism incorporated into the HOCl generation system, in accordance with an embodiment of the present disclosure;

FIG. 26 illustrates a perspective view of a wipe handling device, in accordance with another embodiment of the present disclosure;

FIGS. 27A to 27I show a schematic representation of a wipe handling device, in accordance with another embodiment of the present disclosure;

FIG. 28 illustrates a front view of a wipe handling device 2800, in accordance with another embodiment of the present disclosure;

FIG. 29A illustrates a perspective view of a wipe roll, in accordance with at least some embodiments of the present disclosure; and

FIG. 29B illustrates a perspective view of one or more activator capsules, in accordance with at least some embodiments of the present disclosure.

The drawings referred to in this description are not to be understood as being drawn to scale, except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as not to unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described, which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various embodiments of the present disclosure relate to a wipe handling device configured to store, infuse, generate, and dispense disinfectant-treated wipes, such as those infused with hypochlorous acid (HOCl). The wipe handling device is intended to improve sanitation, hygiene, and user convenience in a wide variety of environments, including but not limited to homes, offices, healthcare facilities, educational institutions, gyms, restaurants, and other commercial or industrial settings.

The wipe handling device includes a container having one or more chambers, preferably separate, with a first chamber designed to accommodate a roll or stack of dry or pre-moistened wipes, and a second chamber designed to hold a liquid wipe solution such as water, saline, or a disinfectant precursor. In certain embodiments, the wipes may be stored dry and subsequently infused with the solution inside the device prior to dispensing, ensuring optimal freshness and effectiveness.

The wipe-infusing mechanism of the wipe handling device may be implemented in a variety of configurations, each designed to deliver a cleaning or disinfecting solution, HOCl, into a dry or pre-moistened wipe before it is dispensed. In one embodiment, the mechanism includes a roller assembly comprising a driver roller and a driven roller positioned such that the wipe passes between them. These rollers apply pressure to the wipe and may be mechanically or electrically coupled to a pump that delivers the solution from a reservoir, thereby allowing for infusion of the solution during the wiping motion. In another embodiment, the wipe is passed through a belt drive system, which includes a transmission belt coupled to a set of rollers. The belt may retain and carry the wipe solution and transfer it onto the wipe as it moves along the belt. A compression roller, biased by resilient members such as springs or elastomers, may press the wipe against the belt to facilitate uniform distribution of the solution. A cam mechanism and user-operable actuator may be included to adjust the compression force, thereby enabling control over the saturation level of the wipe. In yet another embodiment, the wipe-infusing mechanism includes a fluid treatment section, such as an infusion tray or soaking path, where the wipe is directed into contact with a volume of solution stored within the container. A pump may draw fluid from the solution reservoir and deliver it into this treatment section. The wipe, guided by internal flaps or channels, may absorb the solution through passive soaking or assisted flow mechanisms. Additional embodiments may include swingable or pivoting flaps that assist in guiding the wipe along a predefined path through the infusion components, while also facilitating access for replacing the wipe roll. These flaps may be positioned radially inward from the sidewalls of the container and may be resilient or flexible in nature.

The wipe handling device further incorporates an electrolysis generation system configured to produce disinfectants, most notably hypochlorous acid, via electrolysis. The electrolysis unit includes an anode electrode and a cathode electrode, each submerged in an electrolyte solution and powered by a circuit system including a power source, regulator, current and voltage sensors, and a processor. The processor may be configured to dynamically adjust power delivery based on real-time sensor data, including readings from pH sensors, salinity sensors, temperature sensors, and other indicators of solution quality. Advanced circuit configurations, including pulse-generating switches, H-bridge circuits, and capacitor-based energy storage systems, may be used to improve electrolysis efficiency and control over the chemical reaction. Additionally, fluid agitation elements such as pumps, vibrating components, or angled electrodes may be included to enhance fluid circulation and reaction consistency by removing gas bubbles or moving the solution over the electrodes.

For improved usability, the wipe handling device may include one or more user-interaction detection sensors mounted on the lid or housing. These may include infrared, ultrasonic, temperature, sound, Bluetooth, or Wi-Fi-based sensors that detect the approach or departure of a user and activate components accordingly. A motorized lid may open or close automatically in response to detected interaction, and status indicators such as LEDs or sound signals may provide feedback on wipe or solution availability. Altogether, the wipe handling device presents a modular, intelligent, and user-friendly device that ensures the reliable generation and dispensing of disinfectant-infused wipes.

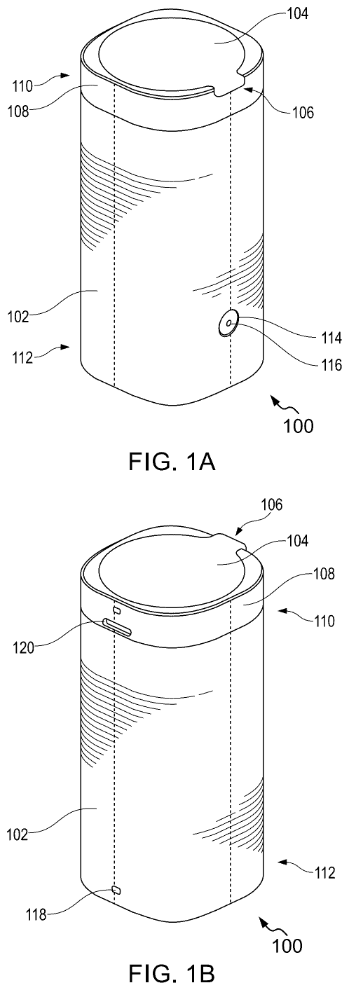

Various example embodiments of the present disclosure are described hereinafter with reference to FIGS. 1A-1B to FIG. 29A-29B.

FIGS. 1A and 1B illustrate perspective views of a wipe handling device 100, in accordance with at least some embodiments of the present disclosure. The wipe handling device 100 includes, inter alia, a container 102 having one or more chambers (not visible in FIGS. 1A and 1B), a wipe-infusing unit (not visible in FIGS. 1A and 1B) operably coupled to one or more chambers, and a lid 104 pivotally coupled to the container 102.

The one or more chambers are configured to accommodate at least one wipe (not visible in FIGS. 1A and 1B, and hereinafter “at least one wipe” is alternatively referred to as “the wipe”) and a wipe solution (not visible in FIGS. 1A and 1B). The wipe-infusing unit, which is disposed within the container 102, receives the wipe and the wipe solution from the one or more chambers. Upon receiving, the wipe-infusing unit is configured to infuse the wipe solution into the wipe at a predetermined concentration, thereby forming at least one infused wipe (hereinafter also referred to as “the infused wipe”). The lid 104 is configured to operate between an openable position (not shown in FIGS. 1A and 1B) and a closable position 106. The openable position of the lid 104 facilitates the dispensing of the infused wipe from the container 102, and the closable position 106 of the lid 104 facilitates sealing of the container 102.

In at least one implementation, the wipe handling device 100 may be configured to utilize a pre-manufactured wipe, which may be either wet or dry, depending on the intended use case. In some embodiments, the pre-manufactured wipe may be pre-saturated with a disinfecting or cleaning solution prior to insertion into the wipe handling device 100. In other embodiments, the wipe may be stored in a dry state and subsequently infused with the wipe solution, such as hypochlorous acid (HOCl) solution, within the wipe handling device 100 prior to use.

Without departing from the scope of the disclosure, in at least one embodiment, the requirement for the wipe is eliminated, and the wipe handling device 100 may be configured as a portable hand sanitizer device, a spray bottle device, or a misting device. In such configurations, the wipe handling device 100 directly dispenses the HOCl solution onto a target surface (e.g., hands of the user, floor, etc.), thereby broadening the applicability of the disclosure to various liquid delivery systems while maintaining the core functionality of generating and delivering an effective disinfecting solution.

Further, in at least one implementation, the wipe solution may be configured as the HOCl solution, a disinfecting agent known for its antimicrobial properties. The one or more chambers may be configured to generate and/or store the HOCl solution. Correspondingly, the one or more chambers may also be configured to generate and/or store the wipes (or a wipe roll) that are infused with the HOCl solution.

In this implementation, the configuration of the one or more chambers may include either a single chamber or multiple chambers, such as two distinct chambers, depending on the specific design requirements and functional considerations. For instance, in a dual-chamber configuration, a first chamber (not visible in FIGS. 1A and 1B) may be designated for generating and/or storing the HOCl solution, while a second chamber (not visible in FIGS. 1A and 1B) may be designated for storing a dry wipe or HOCl-infused wipe. Alternatively, in the single chamber design, both the wipe solution and the wipe may coexist within the same, unified chamber, with appropriate internal structures or compartments to manage separation or controlled interaction therebetween. Additional structural and operational details related to these configurations are described in subsequent sections of this disclosure.

In an embodiment, the container 102 incorporates a covering member 108 that is detachably positioned at an upper portion 110 thereof. The covering member 108 serves as a protective barrier and is configured to enclose the upper portion 110 of the container 102, thereby facilitating user access to an interior (not visible in FIGS. 1A and 1B) of the container 102. This configuration allows for convenient refilling or removal of the wipe, inspection of internal components (e.g., the first chamber, the second chamber, etc.), and routine maintenance or servicing of the wipe handling device 100.

Further, a base portion 112 of the container 102 is configured to support ancillary operational features and may include various user interface and power components. For example, in the representative embodiment, the base portion 112 includes at least one user input element 114 (e.g., a power button or function selector), one or more visual indicators 116 (such as light-emitting diode (LED) status lights), and a charging port 118. Without limitation, the charging port 118 may be configured to receive power from an external power source to operate the wipe handling device 100 or to recharge an on-board power storage element, such as a battery or capacitor. The arrangement of these components facilitates ergonomic interaction by positioning them within easy reach and visual range of the user when the wipe handling device 100 is placed on a surface (e.g., ground surface). However, the foregoing configuration should not be construed as limiting. In alternative embodiments, one or more of the foregoing components, such as the at least one user input element 114, the one or more visual indicators 116, or the charging port 118, may instead be disposed on other portions of the container 102, including but not limited to the sidewalls of the upper portion 110. This flexibility in component placement allows the wipe handling device 100 to be adapted for varying design constraints, user preferences, and intended use environments.

In at least some embodiments, the wipe-infusing unit incorporates a user-operable adjustment actuator 120, mounted on an external surface of the covering member 108, which can be moved along a predefined track. The user-operable adjustment actuator 120 is operably coupled to a flow-regulating or dosing component within the container 102, such that the position of the user-operable adjustment actuator 120 directly affects the volume of the wipe solution delivered to each wipe of the wipe roll. For example, moving the user-operable adjustment actuator 120 toward one end of the scale increases the dosage of the wipe solution applied to the wipe, resulting in a wetter wipe, while moving it in the opposite direction decreases the dosage, producing a drier wipe.

To enhance user usability and feedback, the user-operable adjustment actuator 120 is preferably accompanied by a visual scale or graduated indicator, disposed adjacent to the slider track. The scale may include markings or icons representing a spectrum from “driest” to “wettest”, enabling the user to intuitively assess and select the desired wetness level. In some embodiments, the indicator may be backlit, color-coded, or include tactile feedback to support operation in low-light or medical environments. It is to be understood that the specific mechanism for wetness adjustment is not limited to the user-operable adjustment actuator 120. In alternative embodiments, the wipe-infusing unit may include, but not be limited to, a rotary dial, touch-sensitive interface, or digital control system integrated with components of the wipe-infusing unit.

In various embodiments, the geometric profile of the wipe handling device 100, including the container 102, the wipe-infusing unit, and the lid 104, is not limited to any particular shape, dimension, or configuration, as illustrated in the representative embodiment described herein. The container 102 may assume a wide range of geometric forms, including but not limited to cylindrical, cuboidal, rectangular, polygonal, oval, conical, or hybrid geometries, depending on aesthetic, ergonomic, and functional considerations. Similarly, the wipe-infusing unit may be internally or externally integrated into the container 102 and may vary in spatial orientation, layout, and volume, depending on factors such as fluid dynamics, wipe orientation, and infusion strategy. The lid 104 may be flat, curved, domed, recessed, or contoured, and may include features, such as hinges, pivot points, locking elements, or seals, all of which may vary in shape and structure.

In various embodiments, at least one of the container 102, the lid 104, and the covering member 108 is made from a polymeric material, such as acrylonitrile butadiene styrene (ABS), polycarbonate (PC), or polybutylene terephthalate (PBT). Other thermoplastics or thermosetting plastics may also be used, including, but not limited to, polypropylene (PP), polyethylene (PE), polyamide (PA), or other suitable plastic materials, depending on the desired mechanical, thermal, or chemical properties. In some embodiments, at least one of the container 102, the lid 104, and the covering member 108 may alternatively be formed from metallic materials, such as aluminum, magnesium, steel, iron, or alloys thereof. The use of metals may be preferred in applications requiring enhanced durability, rigidity, thermal conductivity, or structural support. In additional embodiments, at least one of the container 102, the lid 104, and the covering member 108 may be fabricated from alternative materials, including composite materials, ceramics, biodegradable plastics, or other suitable materials as dictated by the intended use environment or manufacturing considerations.

Without limitation, at least one of the container 102, the lid 104, and the covering member 108 is preferably manufactured using injection molding, particularly when formed from plastic materials, due to their efficiency in high-volume production and ability to achieve complex geometries with tight tolerances. However, other manufacturing processes may also be utilized, including, but not limited to, rotational molding, thermoforming, extrusion, compression molding, machining (e.g., CNC milling or turning), stamping, casting, or additive manufacturing such as three-dimensional (3D) printing. The choice of material and manufacturing method may vary, based at least on cost, design complexity, production volume, required strength, or regulatory constraints.

In some embodiments, the geometric design of the wipe handling device 100 may be compact and vertically oriented for countertop use, while in other embodiments, the wipe handling device 100 may be horizontally extended for wall mounting, under-cabinet installation, or vehicle integration. It is to be understood that the geometric configurations described and depicted in the present disclosure are provided for illustrative purposes only and do not limit the scope of the disclosure. Alternative geometric profiles may be employed in different implementations, as further discussed in subsequent sections of this disclosure.

The wipe handling device 100 is intended for use in a wide variety of environments including, but not limited to, residential settings, such as homes and apartments; educational facilities, such as classrooms and universities; fitness and wellness locations, including gyms and exercise studios; hospitality venues, such as hotels, restaurants, and bars; commercial establishments, including retail stores; vehicles; and healthcare facilities, such as hospitals, health clinics, and dental offices. Notwithstanding these examples, the wipe handling device 100 may be utilized in any other suitable environments or applications, whether clinical or non-clinical in nature. Additionally, the wipe handling device 100 may be configured or adapted to generate disinfectants other than the HOCl via electrolysis or other chemical processes.

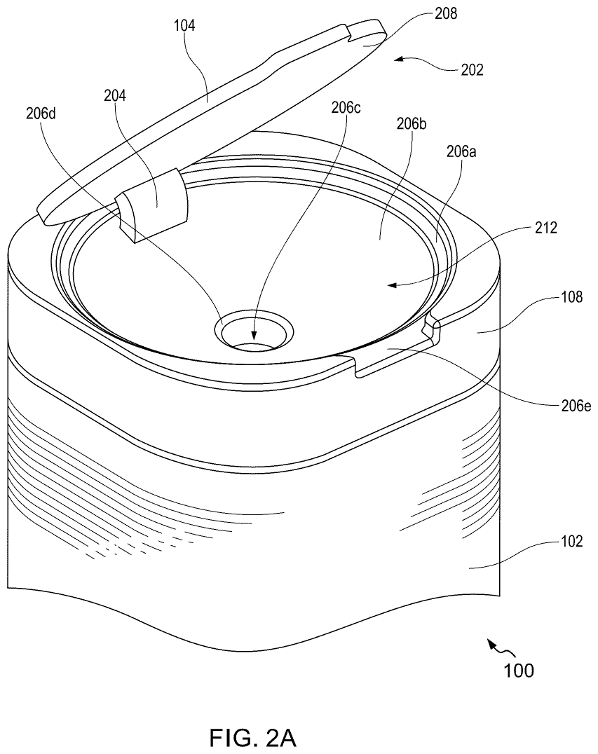

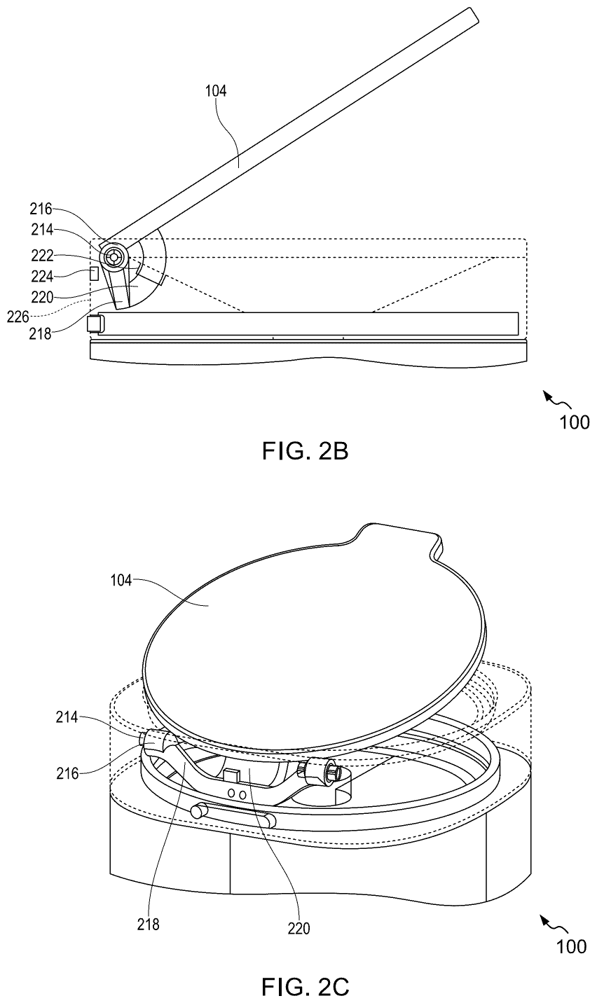

FIG. 2A illustrates a perspective view of a top portion of the wipe handling device 100 with the lid 104 in an openable position 202, in accordance with an embodiment of the present disclosure. FIG. 2B illustrates a front view of the top portion of the wipe handling device 100 with the lid 104 in the openable position 202 and without the covering member 108, in accordance with an embodiment of the present disclosure. FIG. 2C illustrates a perspective view of the top portion of the wipe handling device 100 with the lid 104 in the openable position 202 and without the covering member 108, in accordance with an embodiment of the present disclosure.

As illustrated in FIG. 2A, the lid 104 is pivotally coupled to the container 102, enabling it to transition between the openable position 202 and the closable position 106. More specifically, the lid 104 is operably coupled to the covering member 108, positioned on the upper portion 110 of the container 102, via a hinge mechanism 204. The hinge mechanism 204 facilitates pivotal movement of the lid 104 relative to the covering member 18, thereby allowing the user to access the infused wipe when the lid 104 is in the openable position 202 and to seal the container 102 when in the closable position 106.

In the openable position 202, the covering member 108 is exposed, allowing for the dispensing of the wipe that has been infused with the wipe solution, such as the HOCl solution. The covering member 108 is structurally and functionally designed to serve multiple purposes. For example, in the openable position 202 of the lid 104, the covering member 108 facilitates the dispensing of the wipe, and in the closable position 106, the covering member 108 aids in sealing the container 102 to prevent leakage of the liquid and/or vapor form of the wipe solution.

In an embodiment, the covering member 108 is provided with a perimetric sealing surface 206a that extends along an outer boundary (herein, circumferential boundary) of the covering member 108. The perimetric sealing surface 206a is configured to interface with a boundary of an inner surface 208 of the lid 104. This contact zone serves to reduce or eliminate pathways for leakage of the liquid and/or vapor form of the wipe solution from the interior of the container 102. In certain implementations, the perimetric sealing surface 206a may be constructed of an elastomeric material, such as a soft plastic, rubber, or foam, and may take the form of an O-ring, gasket, or other sealing geometry that provides sealing when the lid 104 is in the closable position 106.

The covering member 108 further includes a sloped surface 206b that extends inwardly from the perimetric sealing surface 206a toward a central, or near-central location, of the covering member 108. When the lid 104 is in the closable position 106, the sloped surface 206b is enclosed. The sloped surface 206b defines a wipe dispensing opening 206c, at the central or near-central location thereof, which serves as an outlet for the container 102 through which the wipe may be dispensed. The sloped surface 206b may be shaped in a conical, concave, convex, or other contoured profile, as required by design and manufacturing considerations. This geometry of the sloped surface 206b enables gravitational drainage of excess liquid (i.e., the wipe solution) from the wipe back into the container 102, thereby maintaining moisture levels and reducing mess during use.

The wipe dispensing opening 206c may be located at the geometric center of the covering member 108 or at an eccentric location, depending on ergonomic, aesthetic, or functional requirements. An edge 206d, such as a rounded or sharp ridge, may be formed at the intersection between the sloped surface 206b and the wipe dispensing opening 206c. The edge 206d helps facilitate the separation of individual wipes when the user pulls from the wipe dispensing opening 206c. Without limitation, the edge 206d may be molded or formed to assist in the cutting, tearing, or dispensing of the single wipe at a time.

Additionally, the covering member 108 includes a resting surface 206e, positioned adjacent to or along an exit path of the wipe, which functions to support the wipe as it is being dispensed. The resting surface 206e may also define a gap that allows a lid actuation tab or user-operable finger tab to extend radially outward beyond the outer profile of the covering member 108, facilitating easy opening of the lid 104.

When the lid 104 is in the closable position 106, the inner surface 208 of the lid 104 and the sloped surface 206b of the covering member 108 collectively define a cavity 212. The cavity 212 provides sufficient clearance to accommodate any portion of the wipe that may protrude through the wipe dispensing opening 206c, without disrupting the seal formed between the lid 104 and the perimetric sealing surface 206a.

In some embodiments, the covering member 108 may include additional surfaces, features, or structural enhancements designed to aid in functionality, manufacturability, or sealing performance. These may include ribs, drainage paths, mounting flanges, or engagement elements configured to interface with the lid 104, the container 102, or other components of the wipe handling device 100.

Referring now to FIGS. 2B and 2C, the hinge mechanism 204 is operably integrated within the covering member 108 of the container 102 and facilitates the pivotal movement of the lid 104. In at least one embodiment, the hinge mechanism 204 is at least partially positioned below the sloped surface 206b of the covering member 108, concealed from user view to maintain a streamlined external profile and reduce potential contamination or interference.

The hinge mechanism 204, in the representative configuration, includes one or more rotational shafts 214 (also referred to as “the rotational shafts 214”), one or more bearing members 216 (also referred to as “the bearing members 216”), the first connector 218, and a second connector 220. The bearing members 216 are configured to support and allow at least partial rotation to the rotational shafts 214. The first connector 218 extends between the bearing members 216, and the second connector 220 that couples the first connector 218 to the lid 104. In this arrangement, the second connector 220 passes through a recess 222 of the sloped surface 206b, enabling pivotal movement of the lid 104 between the openable position 202 and the closable position 106, without disrupting the continuity of the sloped geometry. The recess 222 is dimensioned and shaped to accommodate the arcuate motion of the second connector 220 as the lid 104 pivots.

In the illustrated embodiment, as shown in FIG. 2C, the hinge mechanism 204 includes two rotational shafts and, correspondingly, two bearing members. In this regard, the first connector 218 is configured as a connecting bracket extending bidirectionally from a central region of the container 102 outward toward each of the bearing members 216. Specifically, the connecting bracket connects the first rotational shaft and the second rotational shaft to the respective first bearing member and the second bearing member, which are disposed symmetrically along a centerline of the hinge mechanism 204. This arrangement positions the pivot axis of the lid 104 as high as possible within the container 102 structure, a configuration that enables compact integration while avoiding interference with internal container space, particularly toward the rear of the lid 104.

To simplify manufacturing and assembly, at least two of the lid 104, the first connector 218, the second connector 220, and the bearing members 216 are, in some embodiments, formed as a unitary assembly. Without loss of generality, the rotational shafts 214 may then be secured to the one or more bearing members 216 via screws, press-fit, snap-fit, or other mechanical fasteners as deemed suitable by the design constraints.

In one embodiment, the first connector 218 and/or the second connector 220 may be fabricated from a ferrous or magnetic material, or may be integrated with magnetic or ferrous inserts. A corresponding magnet 224 (or ferrous element) may be embedded or affixed within a sidewall 226 of the covering member 108, establishing a magnetic coupling with the first connector 218 and/or the second connector 220. This magnetic interaction generates a torque that biases the lid 104 toward the closable position 106, thereby enhancing sealing performance and user convenience.

In another embodiment, a magnetic or ferrous component may be embedded within or underneath the lid 104 itself. This may be achieved via overmolding, assembly insertion, surface coatings, or other methods. The magnet or ferrous component positioned beneath the sloped surface 206b, or elsewhere within the covering member 108, may then attract the lid 104, providing closing torque. This magnetic closure mechanism may operate independently or in conjunction with mechanical elements to ensure secure sealing.

Furthermore, one or more components of the hinge mechanism 204, such as the rotational shafts 214, may incorporate a friction hinge or a bimodal hinge. In a specific embodiment, the hinge mechanism 204 embodies a biomodal hinge mechanism. Hereinafter, the term “the hinge mechanism 204” is alternatively referred to as “the biomodal hinge mechanism 204”. The bimodal hinge mechanism 204 is utilized to provide controlled bi-directional torque characteristics. Specifically, the biomodal hinge mechanism 204 is configured to generate a closing force when the lid 104 is in proximity of the closable position 106, and an opening force when the lid 104 is lifted past a predefined critical angle. The predefined critical angle may vary between 0 and 120 degrees above a horizontal reference, depending on design requirements. In the preferred implementation, the predefined critical angle is set to approximately 20 degrees above the horizontal reference, ensuring a tactile and responsive user experience during the lid 104 actuation.

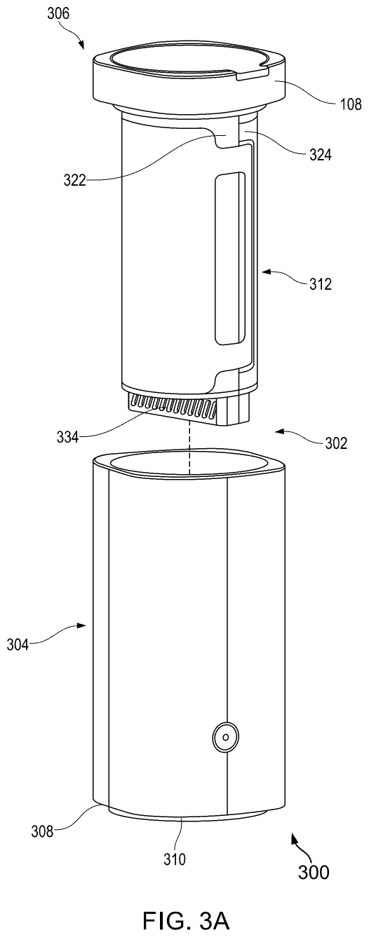

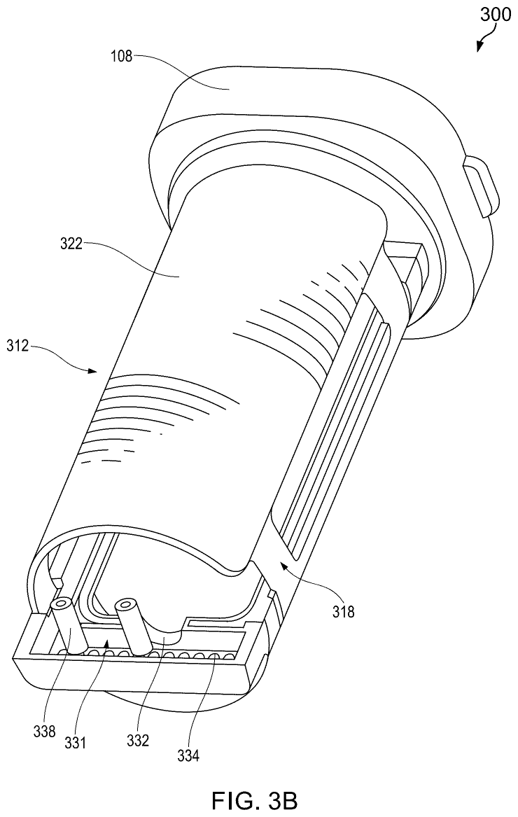

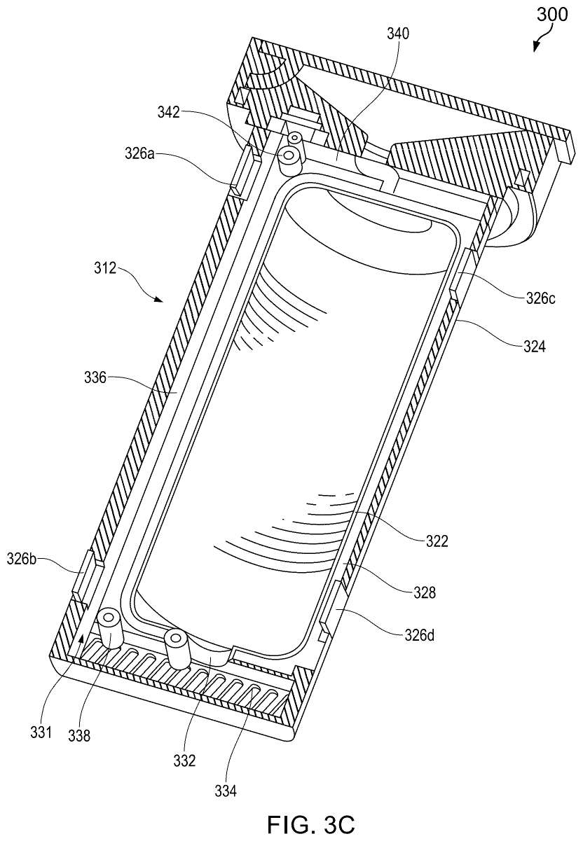

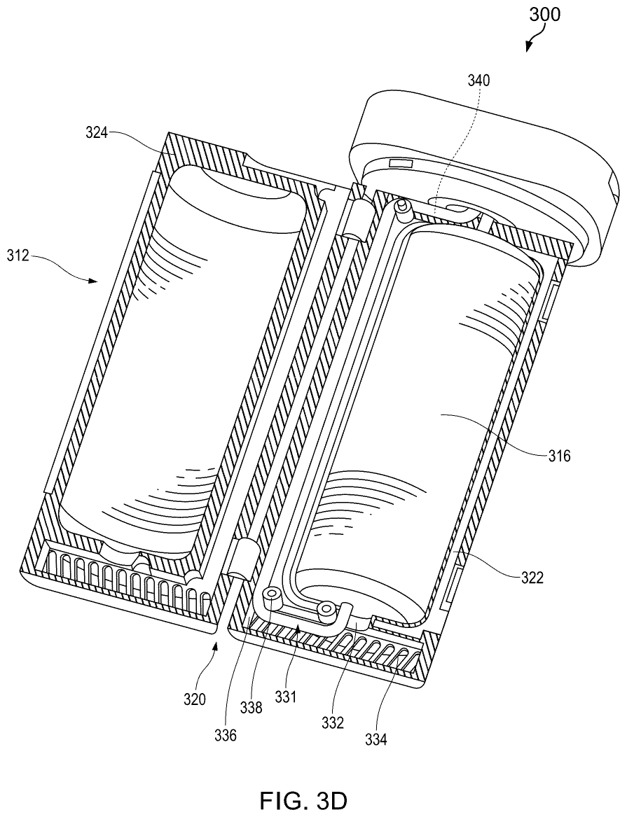

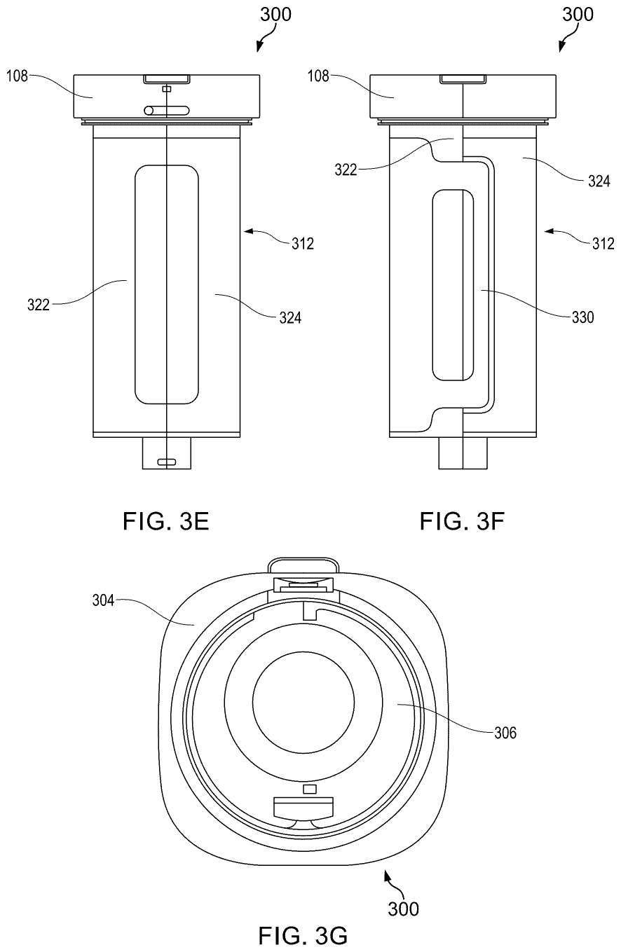

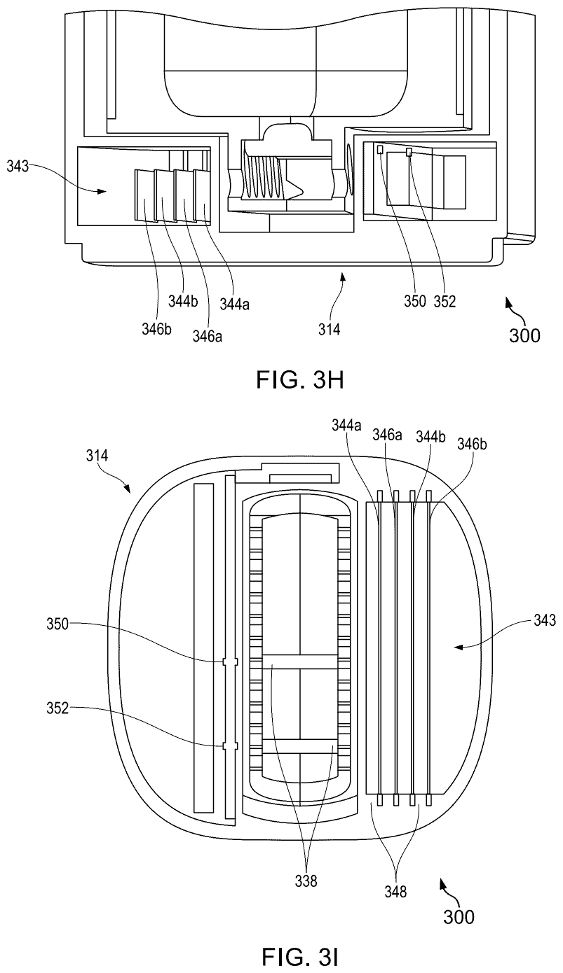

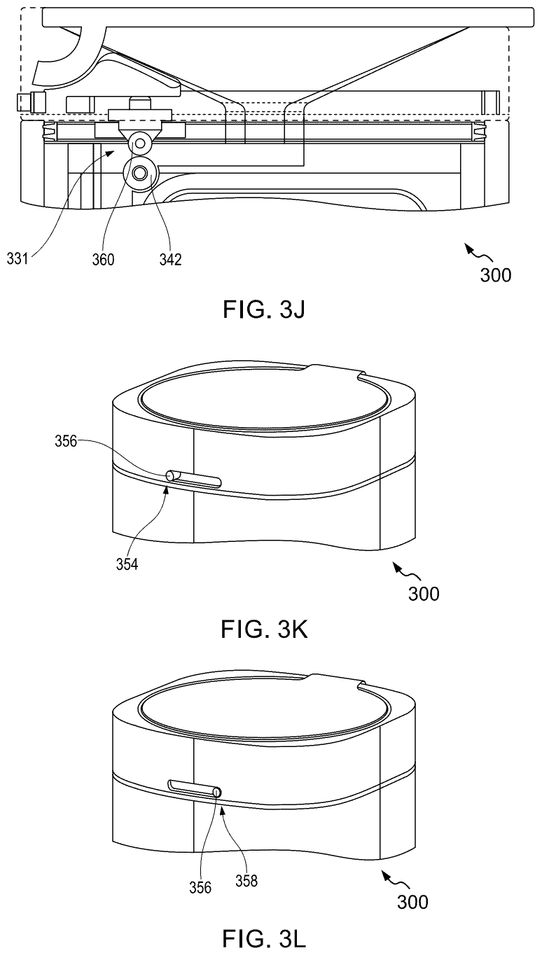

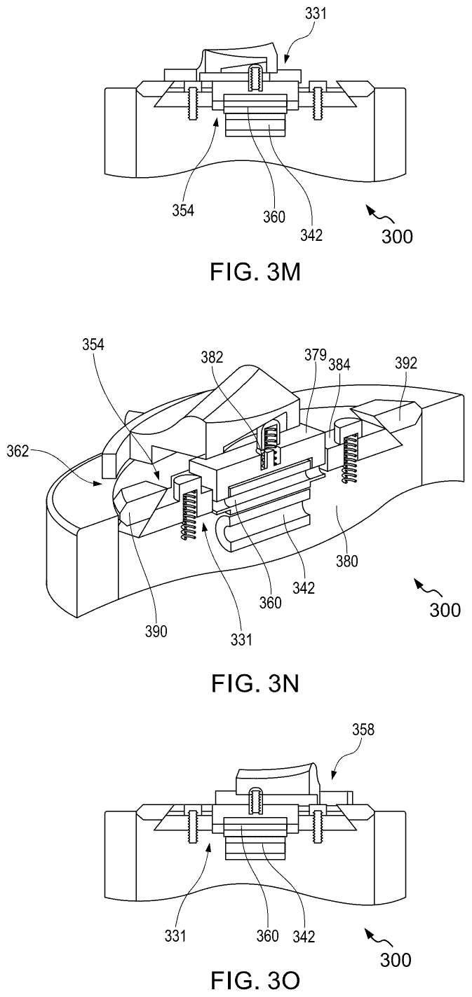

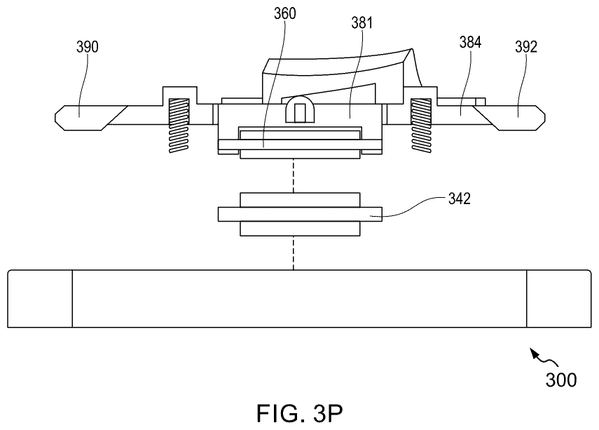

FIG. 3A illustrates an exploded view of a wipe handling device 300, in accordance with an embodiment of the present disclosure. The wipe handling device 300 represents a specific implementation of the wipe handling device 100 described above. The wipe handling device 300 includes a container 302. The container 302 has a housing 304 and an insertable body 306 configured to be slidably received within the housing 304. The housing 304, as disclosed in the representative example, is a hollow structure that defines an internal cavity for slidably receiving the insertable body 306. Without limitation, the housing 304 of the container 302 may further include a bottom section 308 equipped with a stand 310. In an embodiment, the stand 310 may be constructed of a high-friction material, such as rubber, and is configured to enhance the stability of the wipe handling device 300 when placed on the surface (e.g., ground surface).

In an embodiment, a sealing gasket may be provided between the housing 304 and the insertable body 306 to establish a friction seal. The sealing gasket is configured to prevent leakage of liquid and/or vapor forms of the wipe solution or the infused wipe, and to inhibit unintended separation of the covering member 108 from the container 302. In alternative embodiments, other attachment mechanisms may be employed to secure the insertable body 306 to the housing 304. Such mechanisms may include, but are not limited to, hinges, latches, threaded connections, screws, press-fit or interference-fit engagements, detents, magnetic couplings, or other suitable fastening techniques, depending on design and performance requirements.

The insertable body 306 of the container 302 includes one or more chambers 312, 314. The one or more chambers 312, 314 are configured to accommodate at least one wipe 316 (also referred to as “the wipe 316” or “the wipes 316”) and the wipe solution. In a specific embodiment, the one or more chambers 312, 314 include a first chamber 312 and a second chamber 314. The first chamber 312 is configured to receive and store the wipe 316, while the second chamber 314 is configured to contain the wipe solution. The first chamber 312 and the second chamber 314 may be formed integrally within the insertable body 306 or as separate compartments, depending on the design and functional requirements of the wipe handling device 300. Representative examples of the first chamber 312 are illustrated in FIGS. 3B through 3G, and representative examples of the second chamber 314 are illustrated in FIGS. 3H and 3I.

FIG. 3B illustrates a perspective view of the first chamber 312 in a closed state 318, in accordance with an embodiment of the present disclosure. FIGS. 3C and 3D illustrate perspective views of the first chamber 312 in an open state 320, in accordance with an embodiment of the present disclosure. FIG. 3E illustrates a bottom view of the first chamber 312 in the closed state 318, in accordance with an embodiment of the present disclosure. FIGS. 3F and 3G illustrate front views of the first chamber 312 in the closed state 318, in accordance with an embodiment of the present disclosure.

In a representative embodiment, the first chamber 312 is configured as a two-part structure, including a first part 322 and a second part 324, which are operably joined together to form an enclosed volume. An outer rubber cover is disposed over the two-part insert and includes four elastomeric segments, referenced as sections 326a, 326b, 326c, and 326d. The sections 326a and 326b are configured to act as flexible hinge elements, enabling the two parts of the first chamber 312 to fold open relative to each other for access to the wipes 316, for instance, the wipe roll.

When the two parts of the first chamber 312 are moved into the closed state 318, the four elastomeric sections 326a, 326b, 326c, and 326d are placed under mechanical tension. The mechanical tension creates compressive force along a gasket surface 328 located between the first part 322 and the second part 324, thereby establishing a seal that is resistant to leakage of liquid and/or vapor from the internal volume. The sealing mechanism serves to isolate the internal contents, such as a roll of wipes, from external environmental exposure.

In the representative embodiment, as shown in FIGS. 3F and 3G, one of the elastomeric sections 326a, 326b, 326c, and 326d includes an integrally formed loop 330. The integrally formed loop 330 is configured to engage with a corresponding structure on the opposing part of the insertable body 306, thereby maintaining the closed configuration of the first chamber 312. In alternate embodiments, a closure mechanism may be implemented using various alternative means, including but not limited to: latches, magnetic couplings, interference-fit geometries, mechanical fasteners such as screws or knobs, cables, sliders, or other suitable attachment features.

In at least some embodiments, a wipe-infusing unit 331 of the wipe handling device 300 includes a passage 334 positioned below a discharge port 332 of the first chamber 312. The discharge port 332 is configured to permit the wipe 316 (or a chain of connected wipes 316) to be drawn from the interior of the first chamber 312. The passage 334 is at least partially exposed to the external environment outside the first chamber 312, thereby enabling the chain of wipes 316 to come into contact with the wipe solution, facilitating infusion prior to dispensing.

Further, the wipe-infusing unit 331 includes a plurality of channels 336, 340 defined from the passage 334 towards the wipe dispensing opening 206c, and a plurality of rolling elements 338, 342 disposed alongside at least one of the plurality of channels 336, 340 to guide the wipe 316 through the wipe solution and towards the wipe dispensing opening 206c. The passage 334 leads into a vertical channel 336 of the plurality of channels 336, 340, which extends upward from the passage 334. The vertical channel 336 is configured to guide the chain of the wipes 316 upward, optionally passing over first rolling elements 338 of the plurality of rolling elements 338, 342 positioned proximate a lower portion of the vertical channel 336. In a representative embodiment, the first rolling elements 338 include a pair of opposing rollers that assist in the controlled advancement of the wipes 316.

The vertical channel 336 transitions into a horizontal channel 340 of the plurality of channels 336, 340. The horizontal channel 340 is configured to direct the chain of the wipes 316 from the vertical channel 336 towards a dispensing aperture, such as the wipe dispensing opening 206c defined by the covering member 108. Second rolling elements 342 of the plurality of rolling elements 338, 342 are disposed proximate the junction between the vertical channel 336 and the horizontal channel 340 to assist in guiding and controlling the movement of the wipe 316 through a final segment of the dispensing path.

In alternative embodiments, at least one of the first rolling elements 338 and the second rolling elements 342 may be omitted, substituted, or repositioned based on functional requirements or design constraints. At least one of the first rolling elements 338 and the second rolling elements 342 may include passive rollers, active (motor-driven) rollers, or a combination thereof.

FIGS. 3H and 3I depict schematic representations of the second chamber 314 of the wipe handling device 300, in accordance with an embodiment of the present disclosure. In the representative configuration, the second chamber 314 is implemented as an electrolysis unit 343 configured to generate a disinfecting wipe solution, such as the HOCl solution, from a precursor electrolyte solution (e.g., saline or brine). The electrolysis unit 343 includes at least one anode electrode 344a, 344b (also referred to as “the anode electrode 344a, 344b”) and at least one cathode electrode 346a, 346b (also referred to as “the cathode electrode 346a, 346b”) operably positioned within the second chamber 314. In the illustrated embodiment, the anode electrode 344a, 344 band the cathode electrode 346a, 346b are configured with generally planar geometries and are arranged such that their broad planar surfaces are oriented parallel to the direction of gravitational force (i.e., in vertical alignment), thereby facilitating optimal fluid contact and gas release during electrochemical operation.

The anode electrode 344a, 344b, and the cathode electrode 346a, 346b are disposed in proximity of a lower region of the container 302, which allows for immersion in an electrolyte solution and efficient gas-liquid interface management during electrolysis of the electrolysis unit 343. In some embodiments, the electrolysis unit 343 may be provided with additional anode electrodes and/or cathode electrodes to increase the total active surface area, thereby enhancing the rate of electrolysis generation of the wipe solution.

The anode electrode 344a, 344b, and the cathode electrode 346a, 346b, of at least the representative embodiment, may be formed from or coated with materials that are corrosion-resistant and suitable for long-term electrochemical operation. Suitable electrode materials include, but are not limited to, titanium (Ti), titanium substrates coated with mixed metal oxides (MMO), stainless steel, iridium (Ir), ruthenium (Ru), platinum (Pt), palladium (Pd), rhodium (Rh), nickel (Ni), graphite, lead dioxide (PbO2), and diamond-like carbon (DLC) coatings. In certain embodiments, one or more of the electrodes may include a base metal (e.g., titanium) overlaid with a coating comprising one or more of the aforementioned catalytic or protective materials to enhance durability, conductivity, and electrochemical efficiency.

To ensure electrical isolation and proper spatial arrangement, the anode electrode 344a, 344b, and the cathode electrode 346a, 346b are mounted within the chamber (i.e., the second chamber 314) using a support structure or bracket that includes slots 348. The slots 348 are dimensioned and positioned to securely retain the electrodes (i.e., the anode electrode 344a, 344b, and the cathode electrode 346a, 346b) while preventing physical contact or short-circuiting between opposing electrode pairs.

The wipe handling device 300, in at least one embodiment, includes a circuit board operably coupled to a sensing system including two or more rotation sensors 350, 352 (also referred to as “the rotation sensors 350, 352”) disposed in proximity to the first rolling elements 338. The first rolling elements 338 are configured to facilitate the advancement of the chain of the wipes 316 through the first chamber 312. The rotation sensors 350, 352 are adapted to detect an angular displacement of the first rolling elements 338, thereby allowing monitoring of usage and movement of the wipe 316.

The rotation sensors 350, 352 may include, without limitation, rotary encoders, optical encoders, Hall effect sensors, potentiometers, capacitive position sensors, and fiber optic sensors. In one exemplary configuration, the Hall effect sensors are utilized in conjunction with embedded magnetic or ferromagnetic materials within the first rolling elements 338. As the first rolling elements 338, the embedded magnetic elements periodically pass in proximity to the Hall effect sensors, enabling detection of angular position through magnetic field variation.

In the representative embodiment, the first rolling elements 338 include two rollers, wherein one roller has a slightly larger diameter than the other (e.g., 6.05 mm versus 6.00 mm). This deliberate asymmetry in dimensions of the first rolling elements 338 facilitates enhanced resolution and accuracy in determining the linear displacement of the chain of the wipes 316. By comparing the angular positions of both rollers over time, a system can calculate the cumulative length of the wipes 316 dispensed from the container 302 and store corresponding usage data in an onboard memory or controller.

Alternative sensor types may be employed in other embodiments to achieve similar functionality. For example, absolute angle encoders may be used to directly measure the angular position of the first rolling elements 338. Additional or alternative sensing mechanisms for detecting wipe movement or usage may include, but are not limited to: optical distance sensors, proximity sensors, time-of-flight (ToF) sensors, pressure sensors, force sensors, photoelectric sensors, electrical conductivity-based sensors, capacitive or resistive touch sensors, and ultrasonic sensing modules. Without loss of generality, these sensing mechanisms may further be integrated with a control circuit, microcontroller, or processor that processes the sensor data for a variety of purposes, such as usage tracking, alert generation, maintenance notifications, or depletion prediction. In some embodiments, the sensing data may be transmitted to a user interface, mobile application, or remote monitoring system via wired or wireless communication modules such as Bluetooth, Wi-Fi, or near-field communication (NFC).

FIG. 3J illustrates a frontview of the wipe-infusing unit 331 of the wipe handling device 300, in accordance with an embodiment of the present disclosure. FIG. 3K illustrates a perspective view of a first extreme position 354 of a user-operable adjustment actuator 356 of the wipe-infusing unit 331, in accordance with an embodiment of the present disclosure. FIG. 3L illustrates a perspective view of a second extreme position 358 of the user-operable adjustment actuator 356 of the wipe-infusing unit 331, in accordance with an embodiment of the present disclosure. FIG. 3M illustrates a sectional front view of the user-operable adjustment actuator 356 in the first extreme position 354, in accordance with an embodiment of the present disclosure. FIG. 3N illustrates a sectional perspective view of the user-operable adjustment actuator 356 in the first extreme position 354, in accordance with an embodiment of the present disclosure. FIG. 3O illustrates a sectional front view of the user-operable adjustment actuator 356 in the second extreme position 358, in accordance with an embodiment of the present disclosure. FIG. 3P illustrates a sectional exploded view of the user-operable adjustment actuator 356 in the second extreme position 358, in accordance with an embodiment of the present disclosure.

Referring now to FIG. 3J, the wipe-infusing unit 331, of the representative example, is provided with a rolling member 360, which is disposed in opposing relation to one of the second rolling elements 342. The user-operable adjustment actuator 356 is operatively coupled to the rolling member 360. The user-operable adjustment actuator 356 allows the user to control the concentration of the wipe solution infused into the wipe 316 by adjusting the compressive force applied to it via the rolling member 360. To achieve this, the wipe 316 is fed between the rolling member 360 and one of the second rolling elements 342. Without limitation, the rolling member 360 may be spring-loaded such that a variable amount of the compressive force can be applied to squeeze the wipes 316 exiting the container 302. For instance, in one configuration, the rolling member 360 moves towards one of the second rolling elements 342 via a resilient member, such as a spring or elastomeric component, to exert a compressive force against the wipe 316, as it passes through a nip region defined between the rolling member 360 and one of the second rolling elements 342. The compressive interaction between the rolling member 360 and one of the second rolling elements 342 serves multiple purposes: (i) it assists in flattening the wipe 316 to ensure uniform presentation and controlled ejection; and (ii) it optionally functions to regulate the residual moisture content in the exiting wipe 316 by squeezing excess fluid back into the container 302 or a designated drain path.

In some embodiments, the compressive force applied by the rolling member 360 may be adjustable. The adjustment may be user-actuated via the user-operable adjustment actuator 356, such as a knob, dial, slider, or lever, or it may be controlled electronically via a motorized actuator or solenoid responsive to user input or automated control logic. In other embodiments, the compressive force applied is predetermined and fixed, established by the spring constant or physical configuration of the rolling member 360.

Referring now to FIGS. 3K, 3L, 3M, and 3O, the wipe-infusing unit 331 incorporates a slider mechanism 362 (shown in FIG. 3N) designed to allow manual adjustment of the wetness of the wipe 316. The slider mechanism 362 centers around the user-operable adjustment actuator 356 that enables the user to set the moisture level of the wipes 316 exiting from the container 302. When the slider knob (i.e., user-operable adjustment actuator 356) is positioned to the first extreme position 354 (e.g., left end), the dispense setting yields fewer wet wipes 316; when moved to the second extreme position 358, it yields more wet wipes 316. Visual iconography, such as symbols or gradation bars, may be placed adjacent to the user-operable adjustment actuator 356 to visually indicate the wet-and-dry setting continuum.

Referring now to FIG. 3N, when the lid 104 operates in the closable position 106, the rolling member 360 and one of the second rolling elements 342 are pressed together. This is achieved by cam sliders 390, 392 of the wipe-infusing unit 331. The cam sliders 390, 392 are pushed toward the center of the container 302 by a container inner surface 380. The cam sliders 390, 392 force an operable member 384 downward toward the bottom of the container 302 due to an angled cam surface on each slider (i.e., the cam sliders 390, 392). The operable member 384 supports a plate 379 from the bottom, so when it moves downward, the operable member 384 is free to push downward due to the spring force from 382. The operable member 384 is attached to the rolling member 360 via a shaft (not shown) and pushes it downward. Thus, when the lid 104 is placed in the container 302, the rolling member 360 is moved downward, closer to the one of the second rolling elements 342. In terms of materials, the above-discussed components of the wipe-infusing unit 331, without limitation, are made from injection-molded plastics, such as ABS, polycarbonate (PC), or PBT. Nonetheless, alternate materials, including metals like aluminum, magnesium, steel, or iron, may be substituted based on application requirements. Other manufacturing processes, such as rotational molding, thermoforming, extrusion, machining, stamping, or additive manufacturing, may similarly be employed without departing from the intended structural or functional outcome.

Referring now to FIG. 3P, removing the cover module disengages the cam sliders 390 and 392, allowing them to retract outward under the force of internal springs. This release mechanism lifts component 381, thereby creating a clearance gap between the rolling member 360 and one of the second rolling elements 342. Such separation enables convenient reloading of wipes 316, as the user can easily insert the wipe 316 between the rolling member 360 and one of the second rolling elements 342 without needing special tools or applying manual force.

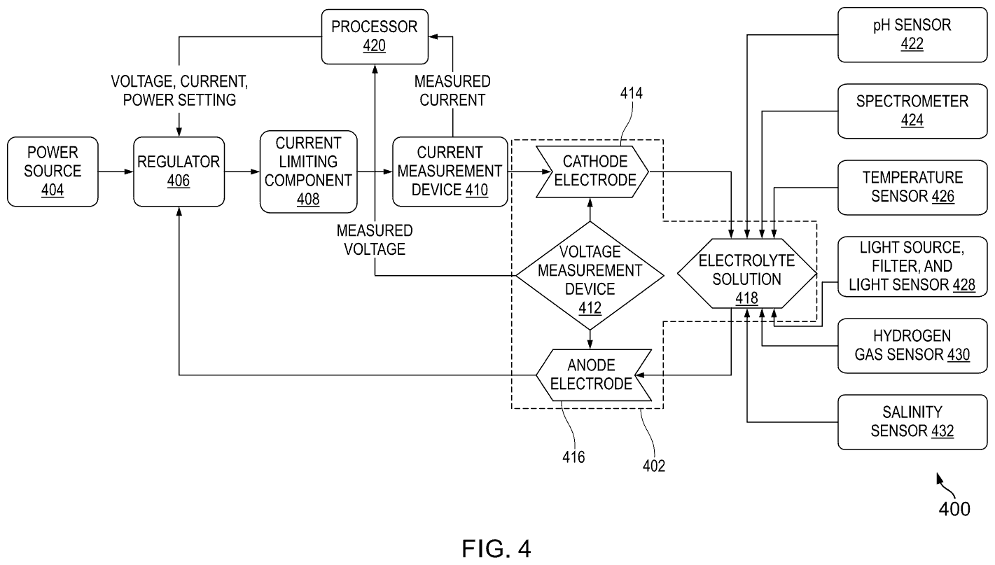

FIG. 4 shows a block diagram representation of an electrical circuit system 400 electrically coupled to an electrolysis unit 402, in accordance with an embodiment of the present disclosure. The electrical circuit system 400 of the wipe handling device, such as the wipe handling device 100, includes a power source 404 configured to supply electrical energy to the electrolysis unit 402. The power source 404 may include, without limitation, an external power supply or an integrated battery, such as lithium-ion, alkaline, or other suitable chemistries. The power source 404 supplies electrical energy to the circuit components. The electrical circuit system 400 further includes a regulator 406, which is electrically coupled to the power source 404. The regulator 406 is configured to control at least one of voltage, current, or power delivered to the electrolysis unit 402. The regulator 406 may include, for example, one or more of a transistor, amplifier, field-effect transistor (FET), buck regulator, boost regulator, low-dropout regulator, or any other suitable adjustable regulator capable of controlling voltage, current, or power output within the electrical circuit system 400.

The electrical circuit system 400, of the depicted embodiment, further includes a current-limiting component 408 electrically coupled to the regulator 406. The current-limiting component 408. The current limiting component 408 is configured to restrict the current supplied to one or more electrodes of the electrolysis unit 402. In the depicted example, the current-limiting component 408 is configured as a current limit switch. The current limit switch is integrated to prevent excessive current flow through the electrodes, thereby protecting the circuit and preventing damage to the electrochemical cell. A current measurement device 410 and a voltage measurement device 412, each configured to measure, respectively, current flowing to and voltage across the one or more electrodes. The one or more electrodes include at least one cathode electrode 414 (also referred to as “the cathode electrode 414”) and at least one anode electrode 416 (also referred to as “the anode electrode 416”), both of which are immersed in an electrolyte solution 418 of the electrolysis unit 402. The electrolyte solution 418 may include, but is not limited to, water with dissolved salts or other ionic compounds necessary for the electrolysis process. A processor 420 is communicably coupled to the current measurement device 410 and the voltage measurement device 412. The processor 420 is configured to receive measurement data and to adjust the output parameters of the regulator 406 based on the received data. The processor 420 may be implemented as a reprogrammable device, such as a microprocessor, field-programmable gate array (FPGA), complex programmable logic device (CPLD), or as a custom, non-programmable application-specific integrated circuit (ASIC).

Optionally, the electrolyte solution 418 can be monitored by various sensors, including but not limited to: a pH sensor 422, a spectrometer 424, a temperature sensor 426, a light source with a light sensor 428, a hydrogen gas sensor 430, and a salinity sensor 432. Each sensor is configured to monitor a property of the electrolyte solution 418 and provide sensor data to the processor 410. For instance, the pH sensor 422 determines the acidity or alkalinity of the solution, the spectrometer 424 analyzes chemical composition or concentration, the temperature sensor 426 monitors the solution temperature, the light source with a light sensor 428 detects optical properties, the hydrogen gas sensor 430 measures gas generation indicative of electrolysis activity, and the salinity sensor 432 assesses ionic concentration. These sensors provide real-time data to the processor 410, enabling dynamic control and optimization of the electrolysis process. The processor 410 is further configured to control the regulator 406 to apply electrical energy to the electrolyte solution 418 until a predetermined amount of chemical product is formed.

In operation, the electrical circuit system 400 applies a controlled voltage and current to the electrodes (i.e., the cathode electrode 414 and the anode electrode 416) immersed in the electrolyte solution 418 until a predetermined concentration or quantity of the HOCl solution is generated. In alternative embodiments, the electrochemical cell and associated circuitry may be adapted to produce other chemical species besides the HOCl solution, depending on the electrolyte composition and input reagents utilized.

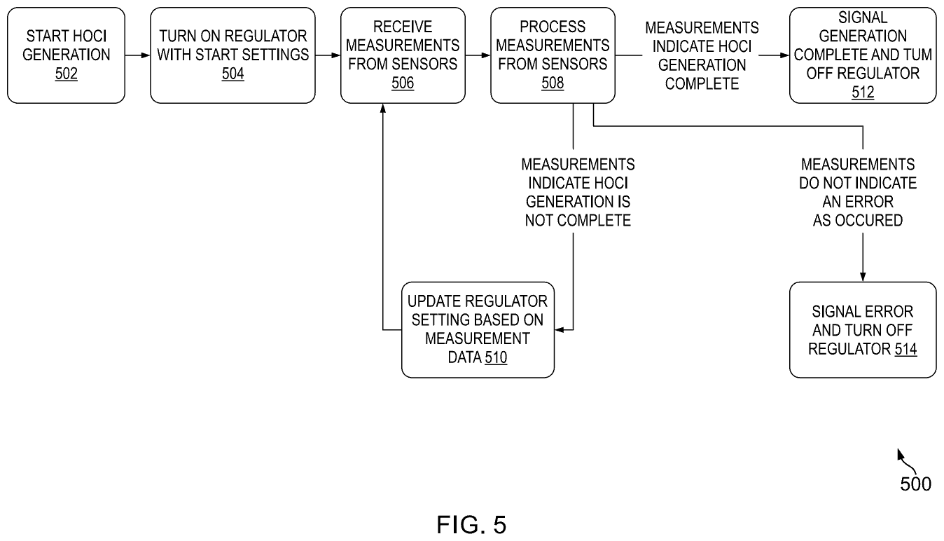

FIG. 5 depicts an illustrative flow diagram of a method 500 for generating a predetermined amount of the HOCl solution within the electrical circuit system 400, in accordance with an embodiment of the present disclosure. The process begins at Step 502, where initiation of generation of the HOCl solution is triggered. This trigger may be activated by various means, including but not limited to a timer expiration, sensor-detected condition, or explicit user input. Upon initiation, the processor (e.g., the processor 410) activates the voltage/current/power regulator at Step 504, setting it to initial operational parameters optimized for the electrolysis process. These parameters may include specific voltage levels, current magnitudes, or power outputs configured to initiate the generation of the HOCl solution.

At Step 506, the processor 410 continuously receives real-time measurements from one or more sensors integrated into the electrical circuit system 400. Such sensors may measure electrical parameters, including voltage and current supplied to the electrodes, as well as optionally other environmental or chemical parameters relevant to the reaction. The received sensor data is processed at Step 508, wherein the processor 410 may perform calculations, such as determining electrical resistance from the measured voltage and current, assessing pH levels, temperature, or other indicators of the progress of the electrochemical reaction.

Following data analysis, the processor 410 executes a decision-making step to evaluate whether the target concentration or quantity of the HOCl solution has been achieved. This determination may be based on direct sensor data, computed parameters, elapsed operational time, or a combination thereof. If the processor 410 concludes that the generation is not yet complete, it proceeds to Step 510, where it may adjust the settings of the regulator 406, including voltage, current, and/or power, to optimize the ongoing reaction. After adjusting the parameters, the processor 410 returns to Step 506 to obtain updated sensor readings, and the cycle of measurement, processing, and evaluation continues iteratively.

Once the processor 410 determines that the desired amount of HOCl has been generated, the process advances to Step 512, wherein the processor 410 signals successful completion of the generation cycle and deactivates the regulator to halt the electrolysis. Alternatively, if an error condition is detected at any time, such as a sensor malfunction, electrical parameters outside the acceptable range, or other fault states, the processor 410 performs Step 514. In Step 514, the processor 410 indicates the error and then disables the regulator to stop operation, thus safeguarding the system and ensuring safety.

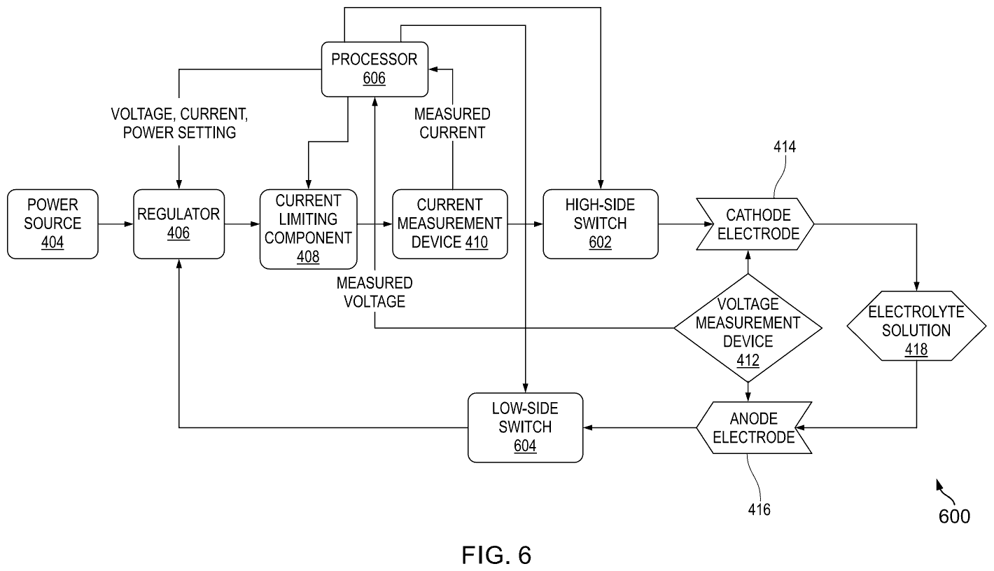

FIG. 6 shows a block diagram representation of an electrical circuit system 600 electrically coupled to the electrolysis unit 402, in accordance with another embodiment of the present disclosure. It is to be noted that the electrical circuit system 600 is another embodiment of the electrical circuit system 400 disclosed in FIG. 4. In the depicted embodiment, one or more switches 602, 604 are electrically connected in series with the anode electrode 416 and the cathode electrode 414 of the electrolysis unit 402. The one or more switches 602, 604 are configured to generate electrical pulses to the electrolyte solution 418 of the electrolysis unit 402. In a specific embodiment, the one or more switches 602, 604 include a high-side switch 602 and/or a low-side switch 604, each operable under the control of a processor 606.

The high-side switch 602 is positioned between the positive terminal of the power source 404 and the electrolyte circuit, while the low-side switch 604 is arranged between the electrolyte circuit and ground, enabling precise modulation of current flow through the electrodes. These switches (i.e., the high-side switch 602 and/or the low-side switch 604) may be implemented using a variety of transistor technologies, including but not limited to Bipolar Junction Transistors (BJT), Junction Field Effect Transistors (JFET), Metal Oxide Semiconductor Field Effect Transistors (MOSFET), Insulated Gate Bipolar Transistors (IGBT), or Silicon Carbide (SiC) devices. The choice of transistor technology may depend on desired switching speeds, power handling capacity, efficiency, and cost considerations.

The processor 606 governs the timing, duration, and frequency of the switching action, thus enabling pulse width modulation (PWM) or other pulsing schemes. Such pulsed current delivery can optimize electrochemical reactions by controlling reaction kinetics, reducing heat generation, improving energy efficiency, or enhancing the production rate and stability of HOCl. By adjusting the duty cycle and pulse frequency of the high-side switch 602 and/or the low-side switch 604, the electrical circuit system 600 can fine-tune the electrolysis process to maintain optimal generation of the desired chemical species within the electrolyte solution 418. This pulsed-current configuration presents advantages, including enhanced control over the electrochemical environment, reduced electrode degradation, and potential for improved longevity and efficacy of the wipe dispensing means.

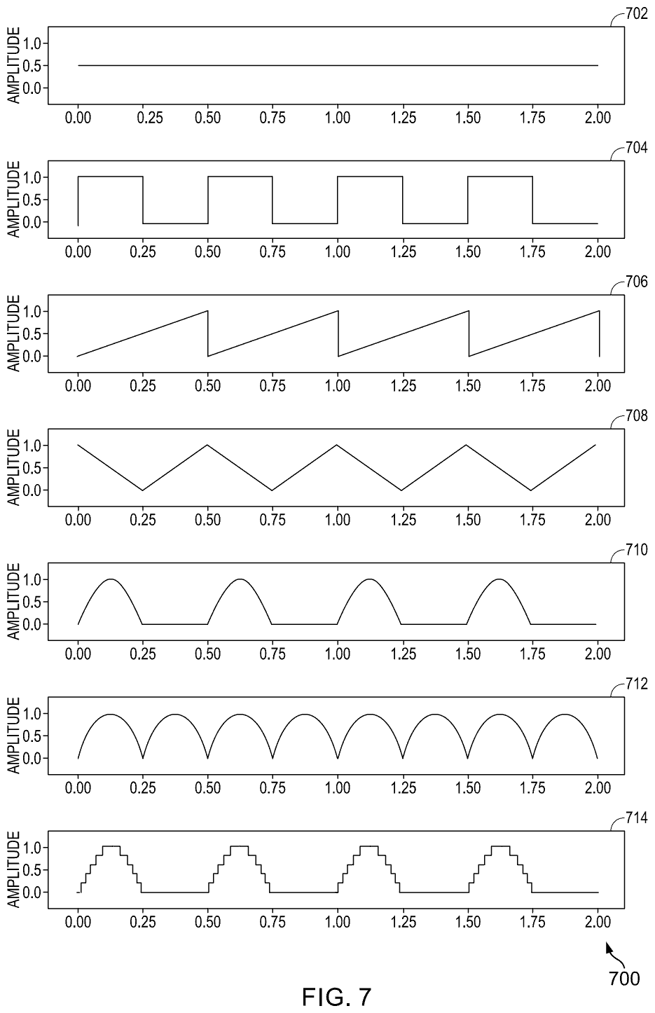

FIG. 7 illustrates various waveforms 700 generated while operating the electrical circuit system 600, in accordance with an embodiment of the present disclosure. As shown, a flow of direct current (DC) 702 through the electrolyte solution 418, as well as various pulsed current waveforms that may be generated using the switching components described in FIG. 6. While continuous DC provides a constant and uninterrupted flow, the use of controlled switching allows for the generation of multiple types of pulsed current signals tailored to optimize the electrochemical reactions within the electrolyte solution 418. These pulsed waveforms may include square pulses 704, which are characterized by abrupt transitions between on and off states, providing a consistent current amplitude during each pulse. Ramp pulses 706 gradually increase or decrease current linearly during the pulse period, which can reduce electrical stress on electrodes and other circuit components. Triangular pulses 708 feature a linear increase followed by a linear decrease in current amplitude, forming a symmetrical waveform that can facilitate smoother electrochemical transitions. Half-wave rectified pulses 710 involve current flow during only one half of an alternating cycle, effectively blocking the opposing half, which may be beneficial for unidirectional electrolysis processes. Full-wave rectified pulses 712 provide pulsed current during both halves of the alternating cycle while maintaining a unidirectional current flow, potentially increasing the effective pulse frequency and improving reaction uniformity. Step response pulses 714 include sudden changes in current amplitude in discrete increments, enabling rapid modulation of the electrochemical environment in response to system feedback or operational needs. Furthermore, combinations or variations of these waveforms may be employed to optimize the HOCl solution generation, enhance energy efficiency, and extend the longevity of system components. The ability to tailor current waveforms provides increased flexibility in controlling the electrolysis process and adapting it to specific applications and desired chemical outputs.

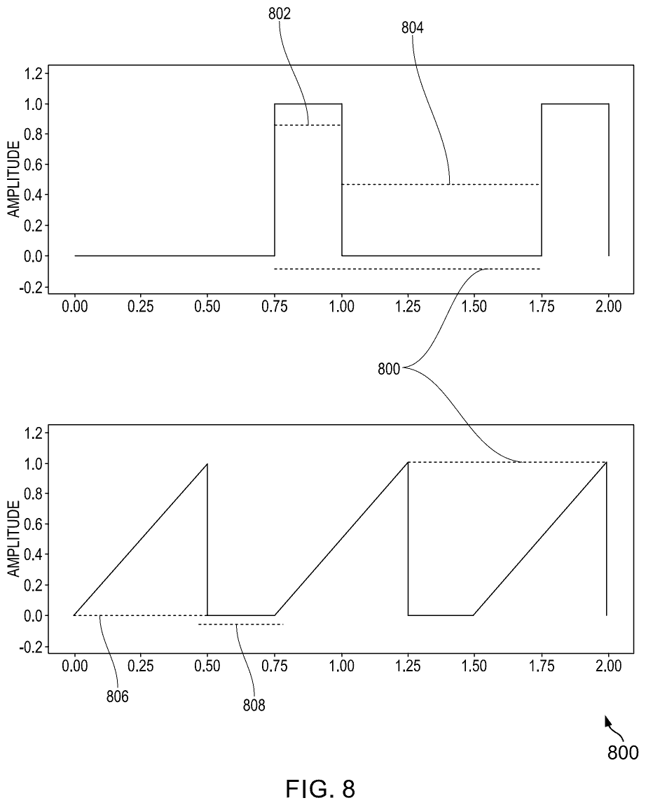

FIG. 8 illustrates the fundamental timing parameters associated with the pulse waveforms, in accordance with an embodiment of the present disclosure. As shown, overall period 800, pulse on time 802, 806, pulse off time 804, 808, and duty cycle, which is defined as the ratio of the pulse on time 802, 806 to the overall period 800. These parameters define the temporal structure of the pulsed electrical signals applied to the electrolyte solution during the generation of HOCl. In various embodiments, these timing parameters may remain fixed for the entire duration of the HOCl generation process or may be dynamically adjusted based on continuous feedback from one or more sensors monitoring the electrolyte solution. Such sensors may provide real-time data related to solution impedance, temperature, salinity, pH levels, optical absorption, or the elapsed activation time. Dynamic modulation of the pulse timing parameters facilitates optimized electrochemical reaction efficiency, enabling precise control over the concentration and production rate of the HOCl solution. Furthermore, adaptive adjustment of pulse characteristics may prolong electrode life by mitigating electrode degradation caused by continuous direct current application. This approach also allows the system to respond to changes in environmental or operational conditions, maintaining consistent performance. The variable pulse parameters described herein can be applied to any of the waveform types depicted in FIG. 7, including, but not limited to, square, ramp, triangular, half-wave rectified, full-wave rectified, step response waveforms, or combinations thereof. Such flexibility in waveform control enhances the versatility and efficacy of the electrochemical generation system.

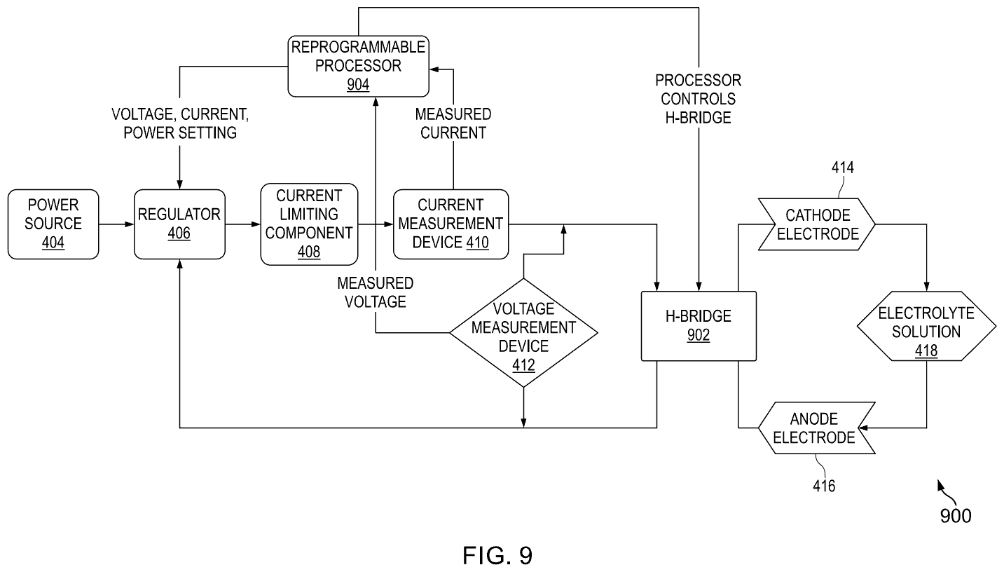

FIG. 9 shows a block diagram representation of an electrical circuit system 900 electrically coupled to the electrolysis unit 402, in accordance with another embodiment of the present disclosure. It is to be noted that the electrical circuit system 900 is another embodiment of the electrical circuit system 400 disclosed in FIG. 4. In this embodiment, the switching configuration of the H-bridge 902 is electrically connected to the anode electrode 416 and the cathode electrode 414, the H-bridge 902 being configured to produce pulsed current and reverse the polarity of the electrodes. The switching configuration of the H-bridge 902 is controlled by a reprogrammable processor 904, which orchestrates the switching sequences to modulate both the timing and direction of current flow through the electrolyte solution 418. The transistors forming the H-bridge 902 may include, but are not limited to, bipolar junction transistors (BJT), junction field-effect transistors (JFET), metal-oxide-semiconductor field-effect transistors (MOSFET), insulated-gate bipolar transistors (IGBT), or silicon carbide (SiC) devices. This polarity reversal capability facilitates alternate anodic and cathodic cycles at the electrodes, potentially improving the efficiency and longevity of the electrochemical generation process by minimizing electrode fouling and passivation. Additionally, the pulsed operation combined with polarity switching enables more precise control over the electrochemical reactions occurring within the electrolyte, allowing optimization of the production rate and concentration of the HOCl solution or other target chemicals. The reprogrammable processor 904 may dynamically adjust the pulse parameters, including frequency, duty cycle, and polarity duration, based on sensor feedback to maintain optimal reaction conditions throughout the operation.

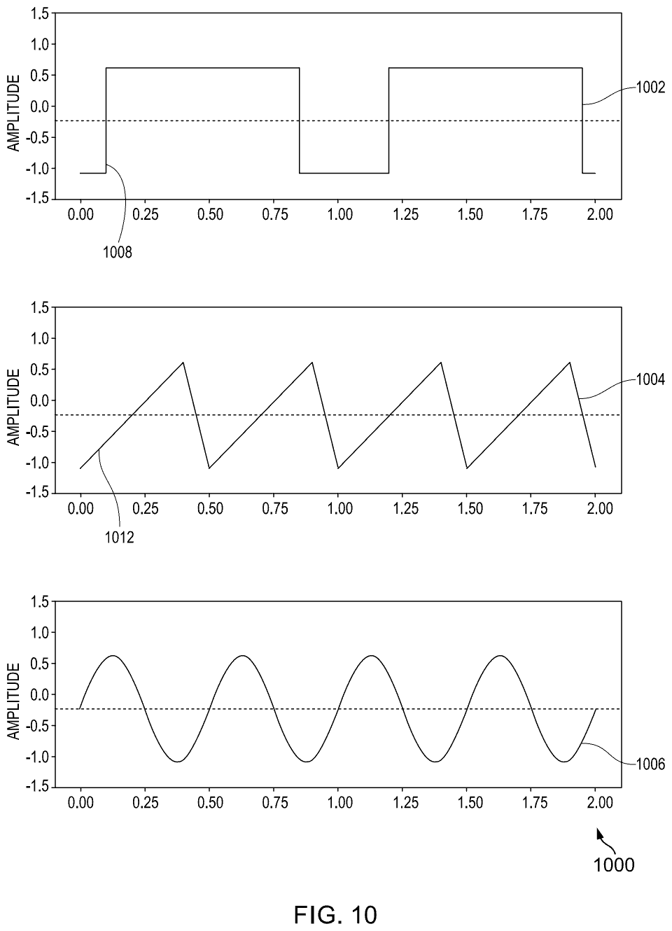

FIG. 10 illustrates various exemplary waveforms 1000 that may be generated using the switching configuration of the H-bridge 902, in accordance with an embodiment of the present disclosure. Herein, various exemplary waveforms that may be generated using the switching configuration of the H-bridge 902 described in FIG. 9 are disclosed. As shown, waveforms include, but are not limited to, square waves 1002, triangular waves 1004, and sine waves 1006. The inclusion of the H-bridge 902 enables the generation of negative voltage signals 1008, thereby allowing the reversal of electrode polarity during operation. Notably, the duration of the positive voltage activation phase need not be symmetrical with the duration of the negative voltage phase 1010. Similarly, the ramp rates or slopes during the positive and negative transitions may differ 1012, allowing for non-linear or asymmetric waveform profiles. Furthermore, the generated waveforms may be offset or otherwise asymmetric with respect to the zero amplitude axis, providing additional degrees of freedom in waveform shaping. These waveform variations allow for fine-tuned control of the electrolysis processes, optimizing factors such as reaction kinetics, electrode longevity, and the concentration of the generated HOCl solution or other chemical species.

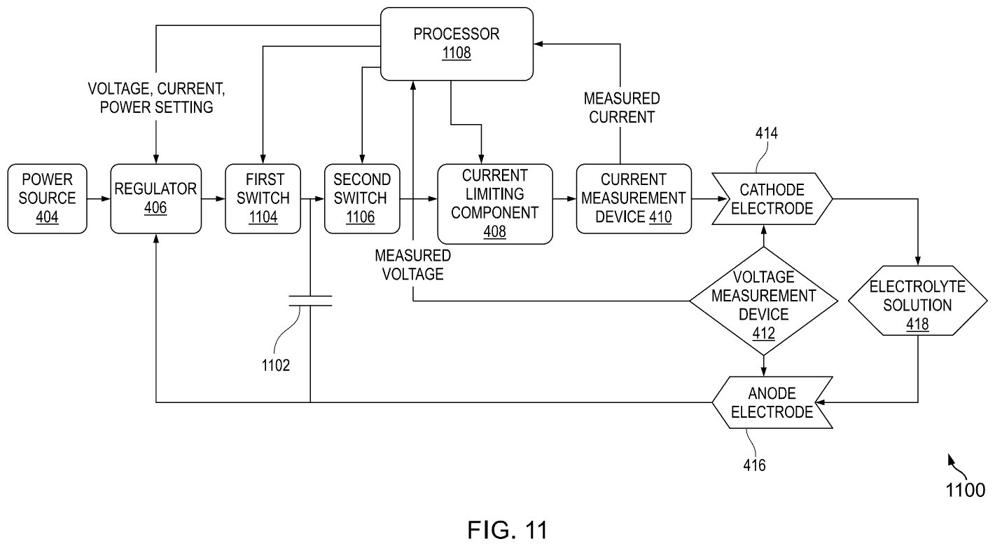

FIG. 11 shows a block diagram representation of an electrical circuit system 1100 electrically coupled to the electrolysis unit 402, in accordance with another embodiment of the present disclosure. It is to be noted that the electrical circuit system 1100 is another embodiment of the electrical circuit system 400 disclosed in FIG. 4.

The present embodiment incorporates an energy storage component, such as a capacitor 1102, which is configured to store electrical energy and deliver high-current pulses to the electrolysis system. The capacitor 1102 can be selectively connected or disconnected from the circuit via a pair of switches 1104, 1106, namely a first switch 1104 and a second switch 1106. These switches are operable under the control of the processor 1108, which manages the timing and duration of the discharge of the capacitor 1102 to regulate the current pulses applied to the electrolyte solution 418. The pair of switches 1104, 1106 may include any suitable transistor types, including but not limited to bipolar junction transistors (BJT), junction field-effect transistors (JFET), metal-oxide-semiconductor field-effect transistors (MOSFET), insulated-gate bipolar transistors (IGBT), or silicon carbide (SiC) transistors. By employing this energy storage and controlled switching arrangement, the circuit can deliver short bursts of high current exceeding the capabilities of a continuous power source, thereby enhancing the efficiency and speed of the HOCl solution generation or other electrochemical reactions. This pulsed high-current approach may also reduce electrode degradation and improve energy utilization within the electrical circuit system 1100.

Embodiments illustrated in FIGS. 4, 6, 9, and 11 may be combined in various configurations to form additional embodiments of the electrochemical circuit system. For instance, the circuit configurations depicted in FIG. 6 and FIG. 11 may be integrated to form a hybrid circuit wherein a capacitor, as described in FIG. 11, is charged through the regulation and switching mechanisms of FIG. 6, including high-side and low-side switches. This combined circuit enables the generation of precisely controlled electrical pulses delivered to the electrolyte solution, leveraging both the capacitor's energy storage capability and the switching control for modulating pulse timing and duration. Such a configuration can improve control over the electrolysis process by allowing for customizable pulse shapes, duty cycles, and current magnitudes, thereby optimizing the production rate and quality of the HOCl solution or other target chemicals. Moreover, integration with features from the regulated power source and sensor feedback loop depicted in FIG. 4, or H-bridge polarity switching of FIG. 9, further enhances the versatility and performance of the system, enabling dynamic adjustment of voltage polarity, pulse characteristics, and real-time monitoring of electrochemical parameters. These combinational embodiments provide increased flexibility, efficiency, and durability in chemical generation applications.

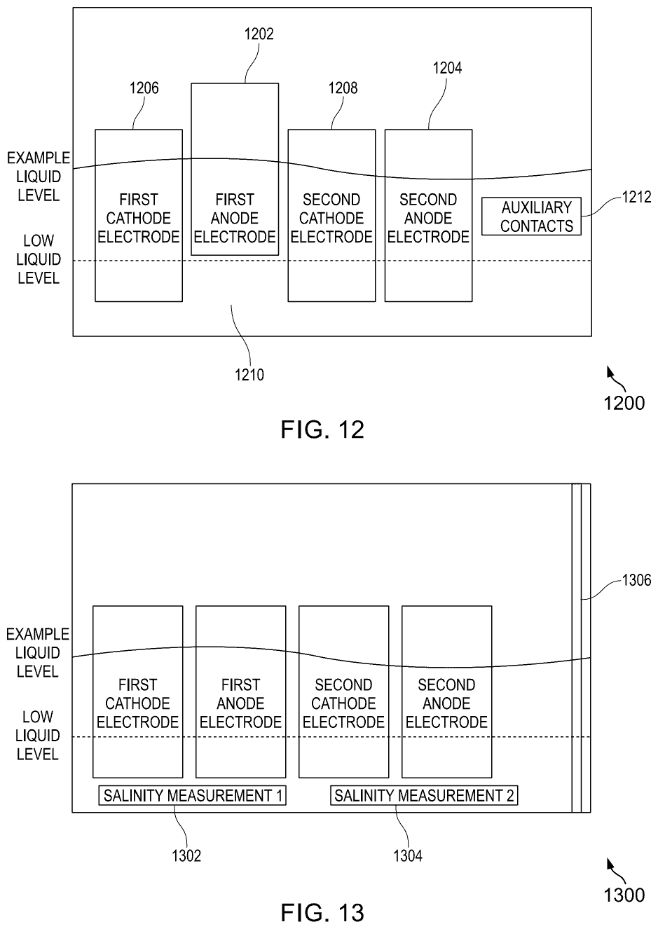

FIG. 12 illustrates an exemplary configuration 1200 of electrodes employed for the generation of HOCl, in accordance with an embodiment of the present disclosure. In this embodiment, one or more electrodes, such as a first anode electrode 1202, are intentionally offset relative to other electrodes, such as a second anode electrode 1204, a first cathode electrode 1206, and a second cathode electrode 1208, within an electrolyte chamber 1210. The positional offset of the first anode electrode 1202 is designed such that when the liquid level within the container falls below a predetermined threshold, the electrode loses direct contact with the electrolyte solution (e.g., the electrotrolysis solution 418), resulting in a significant increase in electrical impedance relative to the remaining electrodes (e.g., the second anode electrode 1204, the first cathode electrode 1206, and the second cathode electode 1208). This change in impedance can be detected through impedance measurement techniques, which may employ one or more multiplexers configured to sequentially measure the impedance between individual electrode pairs. Additionally, one or more auxiliary contacts 1212 may be positioned either within or external to the electrolyte chamber 1210 to serve as supplementary impedance measurement points, thereby enhancing the accuracy and reliability of liquid level detection. Such a configuration enables real-time monitoring of the electrolyte volume and can trigger alerts or automated control responses to prevent operation under low-liquid conditions, which could otherwise lead to suboptimal electrolysis performance or electrode damage. This approach facilitates improved system diagnostics and maintenance, ensuring efficient and safe generation of HOCl or other electrochemically produced solutions.

FIG. 13 illustrates an exemplary configuration 1300 of electrodes employed for the generation of HOCl, in accordance with another embodiment of the present disclosure. FIG. 13 depicts an alternative embodiment of the electrode configuration shown in FIG. 12, incorporating additional electrodes configured for fluid level and salinity measurements within the electrolyte solution. Specifically, a pair of electrodes 1302, 1304 (also referred to as “the electrodes 1302, 1304”) is fully submerged within the electrolyte solution (e.g., the electrotrolysis solution 418) to facilitate accurate measurement of the salinity of the solution by determining the impedance between these two contacts. Concurrently, a vertically oriented electrode 1306 is positioned such that its electrical connection with the solution varies with fluid level. By measuring the impedance between the vertical electrode 1306 and the salinity measurement electrodes (i.e., the pair of electrodes 1302, 1304), a resistance value correlating to the fluid height can be obtained. As the electrolyte solution level decreases, the electrical resistance between the vertical electrode 1306 and the salinity electrodes correspondingly increases due to reduced contact area and diminished conductive path.

The exemplary configuration 1300 utilizes the salinity measurement obtained between electrodes 1302 and 1304 to compensate for variations in the conductivity of the electrolyte, thereby isolating the resistance changes attributed solely to fluid level fluctuations. This compensation enables an accurate determination of fluid level independent of salinity variations. This dual-parameter sensing approach provides improved reliability and precision in monitoring electrolyte conditions, allowing for real-time control and feedback in the electrochemical generation of the HOCl solution or other chemical species. The electrodes 1302, 1304 may be connected to multiplexers and associated signal conditioning circuits to enable sequential impedance measurements and integration with a controlling processor for data analysis and system management.

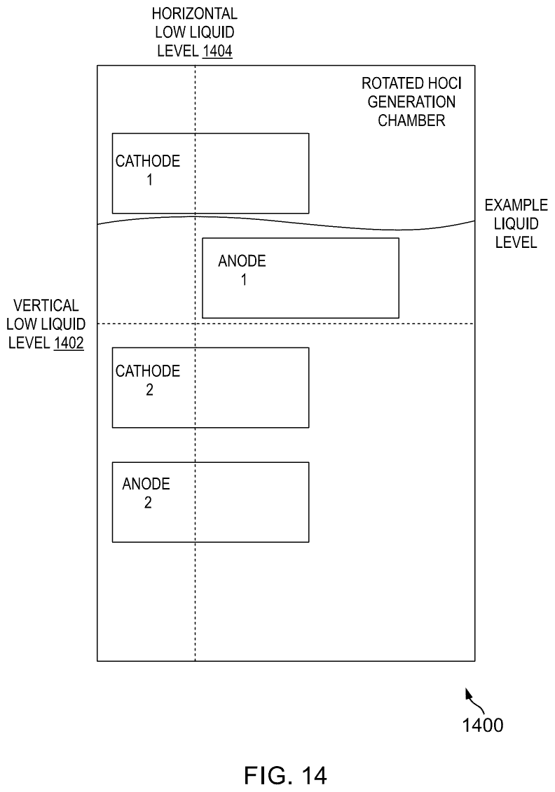

FIG. 14 illustrates an exemplary configuration 1400 of electrodes employed for the generation of HOCl, in accordance with another embodiment of the present disclosure. FIG. 14 illustrates an alternative configuration of the electrode arrangement depicted in FIG. 12, demonstrating that the electrode assembly can be rotated while still maintaining accurate fluid level measurement capabilities. In this embodiment, a vertical low liquid level 1402 is defined relative to the electrode array, along with a horizontal low liquid level 1404. The electrodes are arranged such that the impedance between various electrode pairs can be monitored to detect changes in fluid contact

In this embodiment, as the fluid level varies, the electrodes transition between being fully submerged, partially submerged, or exposed to air, thereby causing measurable changes in electrical impedance. By detecting open circuit conditions or significant impedance increases between specific electrodes, the system can infer the current fluid level with precision, even when the electrode assembly is oriented differently or rotated from its original configuration. This flexible orientation capability enables more versatile placement of the sensing electrodes within containers or chambers of various shapes and orientations, without compromising the accuracy of fluid level detection. The impedance measurements are processed by control electronics, which can utilize multiplexing techniques to sequentially monitor electrode pairs and determine fluid presence or absence based on measured electrical continuity

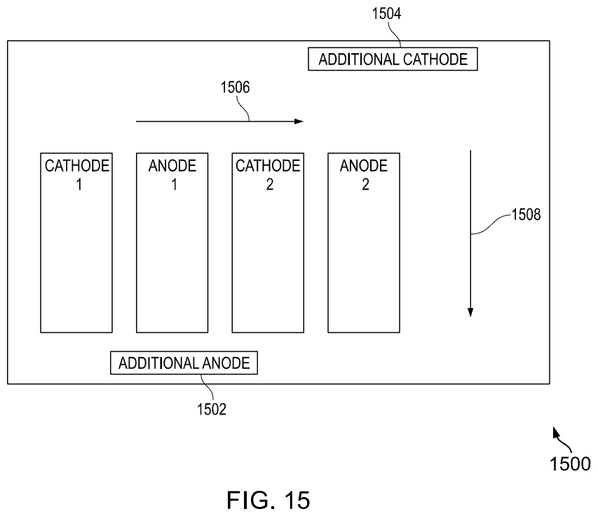

FIG. 15 illustrates an exemplary configuration 1500 configured to enhance fluid dynamics within the electrolyte solution during the HOCl solution generation, in accordance with another embodiment of the present disclosure. In this embodiment, one or more additional electrodes 1502, 1504 (also referred to as “the additional electrodes 1502, 1504”) are positioned at an angle relative to a primary electrodes 1506. This angled orientation creates supplementary electrical forces 1508 that act in conjunction with the primary electrical force generated between the main electrodes.

The combination of primary and angled electrical forces promotes enhanced mixing and convection currents within the electrolyte solution (e.g., the electrolyte solution 418). This increased fluid agitation serves to facilitate the displacement of gas bubbles and reaction by-products away from the electrode surfaces, thereby reducing electrode fouling, improving reaction efficiency, and maintaining consistent electrical contact. Moreover, the additional electrodes 1502, 1504 may be independently driven with pulsed electrical signals, distinct in timing or waveform from those applied to the primary electrodes, such as the primary electrode 1506. This independent pulsing can further increase fluid turbulence and agitation, providing enhanced control over the flow dynamics of the electrolysis and improving overall chemical generation performance. This configuration allows for improved operational stability and efficiency by actively managing the electrolyte environment around the electrodes.

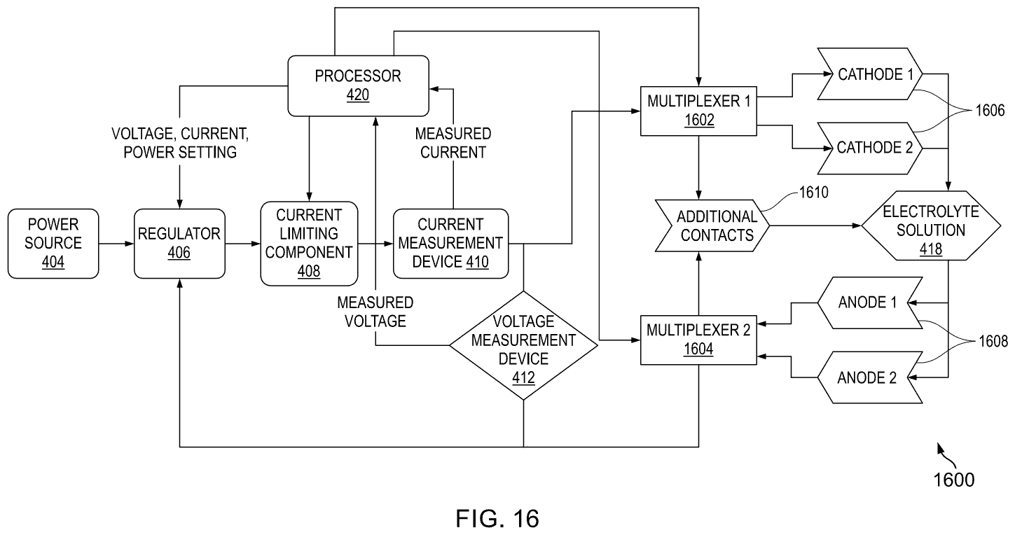

FIG. 16 shows a block diagram representation of an electrical circuit system 1600 electrically coupled to the electrolysis unit 402, in accordance with another embodiment of the present disclosure. FIG. 16 illustrates a modified configuration of an electrode system that integrates one or more multiplexers 1602, 1604 (also referred to as “the multiplexers 1602, 1604”) to selectively connect and measure impedance across multiple electrodes and contacts. The electrical circuit system 1600 may include one or more sets of cathode electrodes 1606, one or more sets of anode electrodes 1608, and additional sensing contacts 1610 arranged as described in the embodiments of FIGS. 12, 13, 14, and 15.

The multiplexers 1602, 1604 enable sequential or simultaneous switching between different pairs or groups of electrodes and contacts, thereby facilitating comprehensive impedance measurements at various points within the electrolyte solution. This configuration allows for dynamic monitoring of fluid properties, such as electrolyte level, salinity, and chemical composition, by analyzing the impedance characteristics between selected electrodes and contacts. In one embodiment, the multiplexing circuit is integrated with the HOCl solution generation circuitry to provide real-time feedback for process control and optimization. Alternatively, the multiplexing system may operate as an independent standalone module, separate from the HOCl generation system, yet utilizing the electrode and contact arrangement depicted in FIG. 16 to perform impedance-based sensing functions.

This modular architecture enhances flexibility and scalability, allowing the system to adapt to various container geometries, electrode arrangements, and sensing requirements. Additionally, the multiplexers 1602, 1604 reduce the number of dedicated measurement channels needed, simplifying the overall electronics while enabling high-resolution spatial sensing across multiple electrodes.

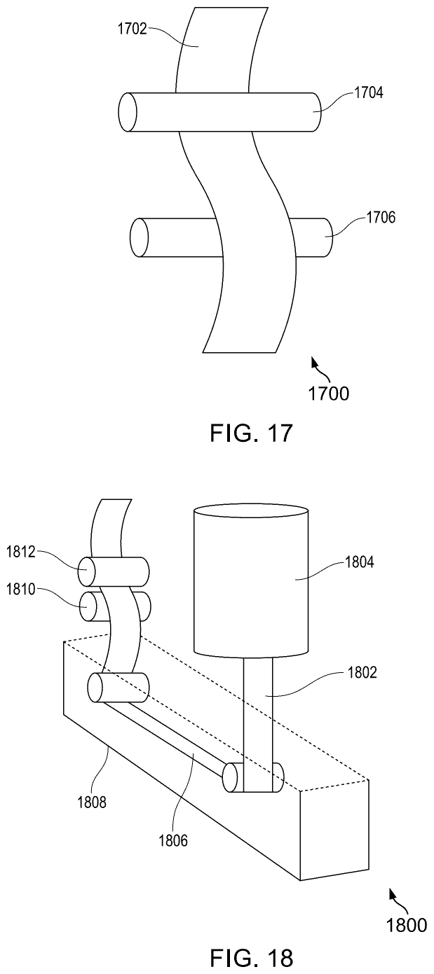

FIG. 17 illustrates an exemplary configuration 1700 of slidable movement of a wipe 1702 (also referred to as “the wipes 1702”) relative to one or more anode electrodes 1704 (also referred to as “the anode electrodes 1704”) and one or more cathode electrodes 1706 (also referred to as “the cathode electrodes 1706”), in accordance with an embodiment of the present disclosure. As shown, the one or more anode electrodes 1704 and the one or more cathode electrodes 1706 are integrated into contact surfaces positioned such that the wipe 1702 slides against them as it is dispensed from the container, such as the container 102. In this embodiment, the wipe 1702 is pre-infused or simultaneously infused with water and the electrolyte solution (e.g., the electrolyte solution 418), allowing the material of the wipe 1702 to act as a conductive medium between the electrodes. As the wipe 1702 is pulled, electrical current flows through the wipe 1702 between the one or more anode electrodes 1704 and the one or more cathode electrodes 1706, thereby facilitating localized electrolysis directly within the wipe 1702.

This localized electrolysis produces the HOCl solution in situ on or within the wipe 1702 itself, activating the wipe 1702 immediately prior to use. Such a configuration offers several advantages, including on-demand chemical activation that maintains the freshness and efficacy of the HOCl solution by reducing degradation that can occur with pre-activated wipes 1702 stored over time. Moreover, this approach simplifies the container design by minimizing the need for bulk electrolysis in a liquid reservoir, potentially reducing device complexity and maintenance requirements.

The one or more anode electrodes 1704 and the one or more cathode electrodes 1706 are preferably constructed from corrosion-resistant conductive materials suitable for electrolysis and the HOCl solution generation, such as titanium coated with platinum or other noble metal catalysts. The contact surfaces are designed to maximize reliable electrical contact with the wipe 1702 while minimizing wear or damage to the wipe 1702 material during dispensing. In some embodiments, the wipe handling device 100 may include a control mechanism, such as a processor, that regulates electrical parameters, including voltage, current, and contact duration, to optimize the HOCl solution production based on the composition of the wipe 1702, environmental factors, or user preferences.

FIG. 18 illustrates a perspective view of an electrode and wipe activation system 1800, in accordance with an embodiment of the present disclosure. As shown, a wipe 1802 (also referred to as “the wipes 1802”) is drawn from a wipe roll 1804 and subsequently passed through a liquid solution 1806 housed within a defined volume 1808. The liquid solution 1806 may consist of pure water, an electrolyte solution (e.g., the electrolyte solution 418), or a chemical precursor solution suitable for the generation of the HOCl solution or other desired chemical activation. As the wipe 1802 traverses the liquid solution 1806, it becomes saturated with the solution, ensuring adequate wetting and impregnation.

Following saturation, the wipes 1802 pass between a pair of electrodes 1810, 1812, which are positioned to contact the wetted wipe surface. The pair of electrodes 1810, 1812 serves to deliver an electrical current through the wipe 1802 material, which, being soaked with the electrolyte solution, acts as a conductive medium. This arrangement facilitates electrolysis directly within the wipe 1802, producing the HOCl solution or other disinfecting agents in situ as the wipe is dispensed.

The inclusion of the defined volume 1808 ensures consistent and controlled saturation of the wipes 1802 prior to activation, improving the reliability and uniformity of the chemical generation process. The pair of electrodes 1810, 1812 is preferably fabricated from materials resistant to corrosion and degradation under electrolysis conditions, such as noble metal-coated titanium or stainless steel. This configuration enhances the efficacy of the wipe activation by combining mechanical wetting with simultaneous electrical activation, providing users with freshly activated disinfectant wipes upon dispensing. Additionally, this embodiment may include sensors and controls to monitor solution level, concentration, temperature, and electrolysis parameters, ensuring optimal chemical generation and wipe performance over the lifetime of the container, such as the container 102.

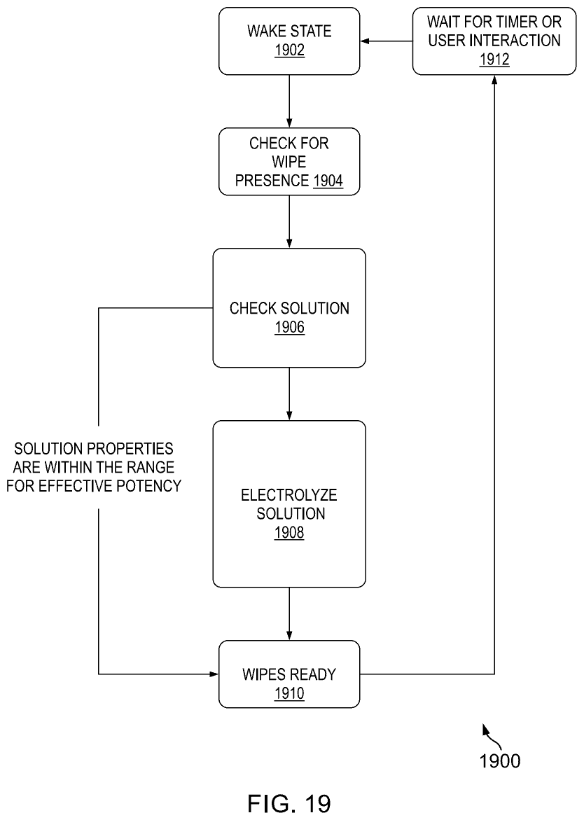

FIG. 19 illustrates an exemplary block diagram outlining a method 1900 for automatically monitoring the availability of both wipes and the HOCl solution within the wipe handling device 100, in accordance with an embodiment of the present disclosure. The process initiates in a wake state 1902, wherein the wipe handling device 100 powers on or activates its electrical components and configures necessary systems to prepare for subsequent operations. Following initialization, the system enters a wipe presence and quantity detection state 1904. In this state, sensors or measurement systems assess whether wipes are loaded within the container and estimate the remaining quantity available for dispensing. This may involve optical sensors, mechanical switches, or impedance-based sensors designed to verify the presence and sufficient stock of the wipes.

Next, the process advances to a solution assessment state 1906, during which the device performs a comprehensive analysis of the HOCl solution or precursor electrolyte solution contained within the reservoir. Parameters that may be evaluated include, but are not limited to, the volume or mass of the liquid present, salinity, pH level, total chlorine concentration, temperature, electrical impedance, hydrogen gas content, and light absorption characteristics. These measurements ensure that the solution is within operational parameters suitable for effective wipe activation and disinfection.

Upon determining that the solution is suitable or requires replenishment, the device may transition to an electrolysis state 1908. In this stage, the system activates electrolysis of the electrolyte solution to generate or regenerate the HOCl solution as necessary, thereby maintaining the chemical concentration needed for effective disinfection. After electrolysis is complete, the device enters a ready state 1910, signaling that the wipes and solution are both available and appropriately conditioned for use. In this state, the device may also provide user feedback indicating readiness for wipe dispensing. Finally, the system enters a wait state 1912, during which it remains idle or in low power mode, awaiting either a predetermined timer interval or user interaction to restart the monitoring cycle. This cyclical process ensures continuous availability and optimal performance of the wipe dispensing system with minimal user intervention.

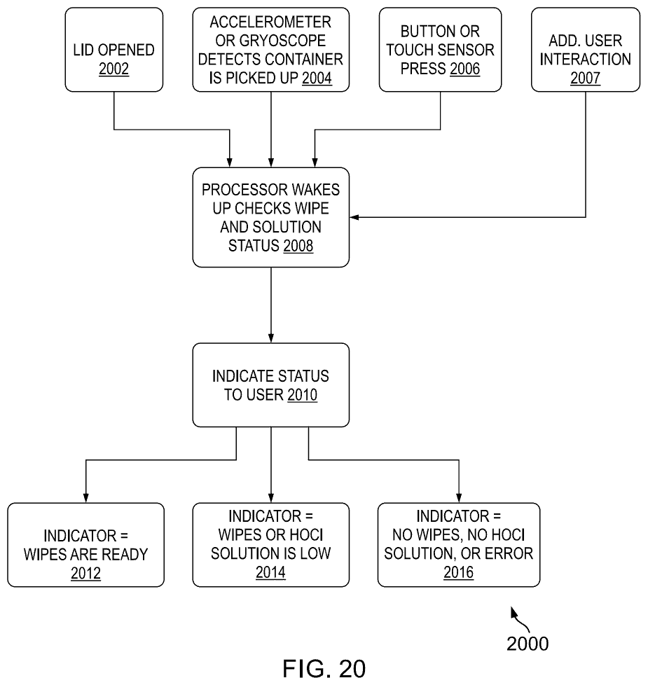

FIG. 20 illustrates an exemplary block diagram depicting a method 2000 for user interaction with the wipe handling device 100, in accordance with an embodiment of the present disclosure. The interaction sequence may be initiated by various activation events, including, but not limited to, opening the lid of the container 2002, detection of the container 102, 302 being picked up through an accelerometer or motion sensor 2004, pressing a physical button located on a device 2006, or other user inputs 2007. Additional user interactions can include voice commands, ambient noise detection, receipt of messages via a dedicated mobile application or remote server, or wireless communications through protocols such as Wi-Fi or Bluetooth.

Upon detection of any of these activation events, the processor (e.g., the processor 420) enters a wake state 2008, wherein it powers on or transitions from low power mode to active mode. During the wake state 2008, the device may perform status checks to assess the availability and condition of the wipes and electrolyte solution, or utilize previously stored status information.

Following these assessments, the processor initiates the activation of one or more user interface indicators 2010 designed to convey the operational status of the wipe handling device 100 to the user. These indicators can include visual elements such as LEDs, display screens, light pipes, glow rings, or other forms of lighting, as well as auditory signals produced by integrated speakers. The device may also provide mechanical feedback or vibration, and display notifications through an associated mobile application or other connected devices. The combination of these sensory outputs 2012, 2014, 2016 serves to inform the user of the readiness of the device, such as the wipe handling device 100, wipe availability, electrolyte status, or any errors requiring attention, thereby enhancing user experience and ensuring effective operation of the wipe dispensing system.

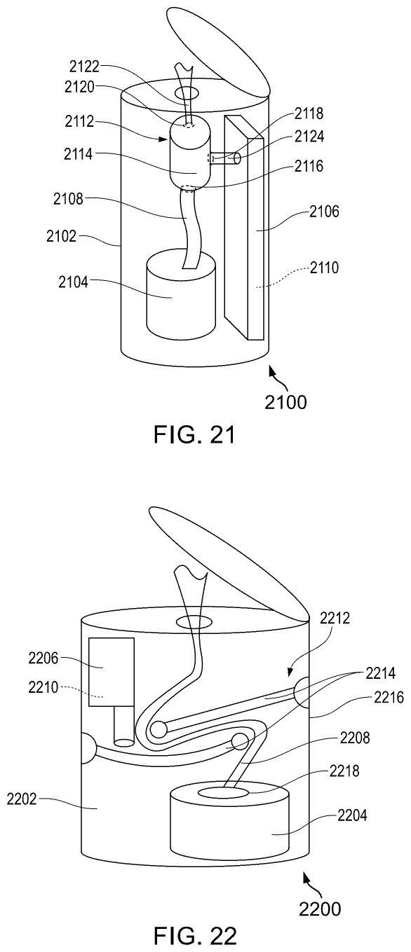

FIG. 21 illustrates a perspective view of a wipe handling device 2100, in accordance with another embodiment of the present disclosure. In the representative example, the wipe handling device 2100 includes a container 2102, which includes one or more chambers 2104, 2106. The one or more chambers 2104, 2106 include a first chamber 2104 for accommodating at least one wipe 2108 and a second chamber 2106 for accommodating a wipe solution 2110. A wipe-infusing unit 2112, of the representative example, includes an infusion section 2114 configured to infuse the wipe solution 2110 into the wipe 2108. The infusion section 2114 incorporates a first inlet 2116 for receiving the wipe 2108 dispensed from the first chamber 2104, a second inlet 2118 for receiving the wipe solution 2110 from the second chamber 2106, and an outlet 2120 for delivering an infused wipe 2122. The wipe-infusing unit 212 further includes a pump 2124 fluidically connecting the second chamber 2106 to the second inlet 2118 of the infusion section 2114. The pump 2124 is configured to supply the wipe solution 2110 from the second chamber 2106 to the second inlet 2118 of the infusion section 2114. The pump 2124 may be electrical, capillary, or mechanical and activated by a button or lever, the lid 104, or by the pull of the wipe 2108.

FIG. 22 illustrates a perspective view of a wipe handling device 2200, in accordance with another embodiment of the present disclosure. In the representative example, the wipe handling device 2100 includes a container 2202, which includes one or more chambers 2204, 2206. The one or more chambers 2204, 2206 include a first chamber 2204 for accommodating at least one wipe 2208 and a second chamber 2206 for accommodating a wipe solution 2210. A wipe-infusing unit 2212, of the representative example, includes one or more flaps 2214 operably coupled to a sidewall 2216 of the container 2202. The one or more flaps 2214 extend radially inward from the sidewall 2216 and are configured to at least swing and rotate relative to the sidewall 2216 container wall of 2216 of the container 2202, The one or more flaps 2214 are further configured to guide the wipe 2208 dispensed from the first chamber 2204 along a predefined path and to facilitate replacement of a wipe roll 2218.

The wipe-infusing unit 2212 further includes at least one treatment section 2220 fluidically coupled to the second chamber 2206. The at least one treatment section 2220 is configured to receive the wipe solution 2210. The at least one treatment section 2220 is positioned along the predefined path to infuse the wipe solution 2210 into the wipe 2208.

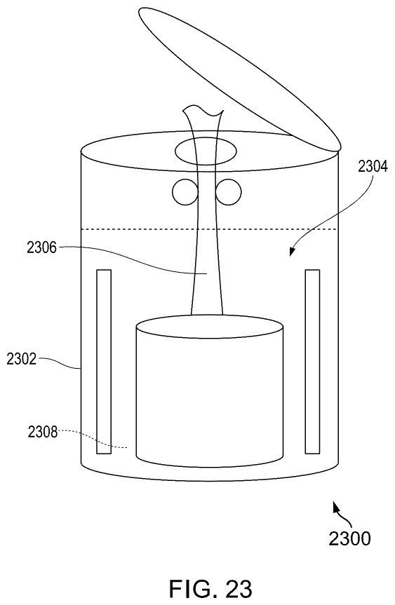

FIG. 23 illustrates a schematic representation of a wipe handling device 2300, in accordance with another embodiment of the present disclosure. In the representative example, the wipe handling device 2300 includes a container 2302, which includes one or more chambers 2304. The one or more chambers 2304 have a single chamber. The single chamber is configured to accommodate both wipes 2306 and a wipe solution 2308.

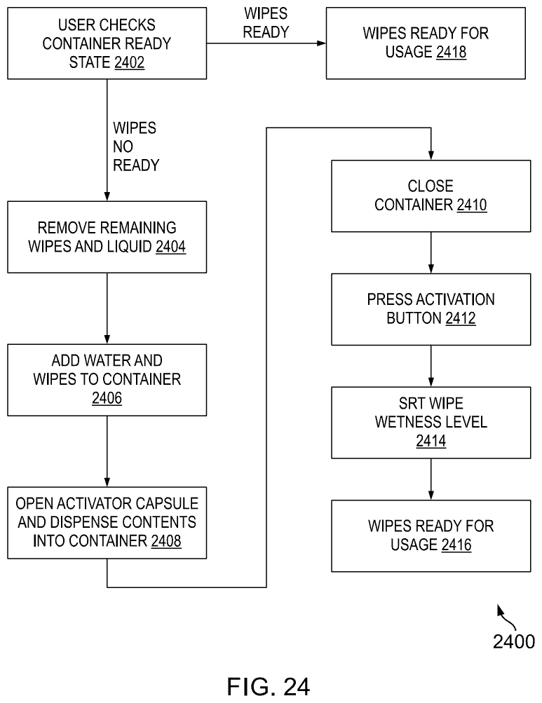

FIG. 24 illustrates an exemplary method 2400 for a user to replenish the wipe handling device 100, in accordance with an embodiment of the present disclosure. In the preferred embodiment, the user first verifies the ready state of the container 2402. This may be indicated through visual or auditory signals such as LED indicators, screen prompts, app notifications, or other user feedback mechanisms integrated into the device. If the container is confirmed to be in a “ready” state, the user may proceed to dispense wipes directly from the device.

However, if the container indicates a “not ready” or “low supply” status, a systematic replacement procedure is initiated, beginning with the step of removing any remaining wipes and residual liquid from the container 2404. This ensures that any depleted or expired materials do not interfere with the performance of the newly added components. The user may dispose of the remaining contents as per guidelines or local waste regulations. Subsequently, the user adds a new roll of wipes and fills the container with water up to a specified level or as instructed 2406. The wipes may be dry or pre-treated with chemical ingredients, and the water may be sourced from a household faucet, bottle, or other sanitary supply.

Next, the user opens an activator capsule 2408, a pre-packaged capsule containing one or more ingredients such as salt, acetic acid, vinegar, citric acid, pH buffers, fragrances, or chemicals like sodium dichloroisocyanurate, and dispenses the contents into the container. These ingredients serve as precursors for in-situ generation of cleaning or disinfectant solutions, including the HOCl solution, when combined with water and activated by the electrolysis unit 402.

After loading the required components, the user closes the container securely 2410 to ensure a leak-proof seal and appropriate compression for internal mechanisms such as the roller assembly and fluid-tight chambers. The user then presses an activation button 2412 or triggers the process through other interfaces, such as a mobile app or sensor activation, to initiate the internal chemical process. This may include initiating the electrolysis function, validating sensor readings, and preparing the solution for wipe infusion.

Following activation, the user may optionally set the desired wipe wetness level 2414 via an adjustable mechanism, such as a slider, rotary knob, or digital interface. This allows the user to customize the moisture content of the wipes dispensed, ranging from lightly moistened to fully saturated, depending on the intended use case (e.g., sanitization, pet care, surface cleaning, or personal hygiene). Upon successful completion of the above steps, the system transitions to a “ready” state 2418, and the wipes are prepared for use 2416. The container may now resume normal dispensing operation, with all internal processes calibrated to accommodate the newly loaded materials.

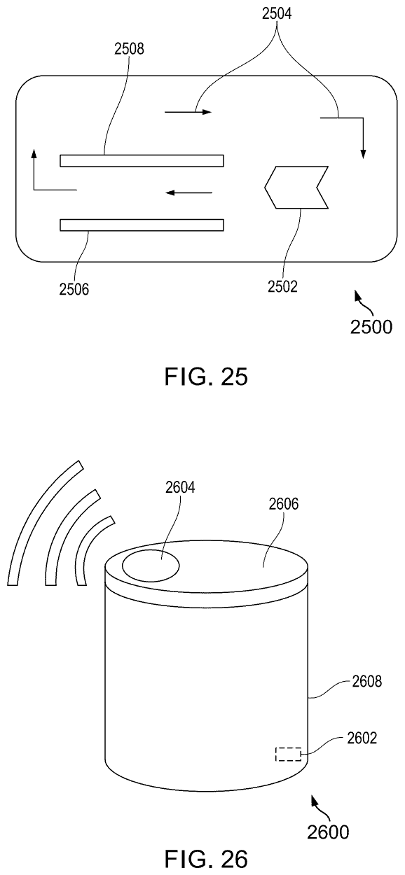

FIG. 25 illustrates a schematic representation of a fluid circulation mechanism 2500 incorporated into the HOCl generation system, in accordance with an embodiment of the present disclosure. In this embodiment, a pump 2502 is positioned within the container to encourage the circulation of an electrolyte solution 2504 around electrodes 2506, 2508. The primary function of the pump 2502 is to move the electrolyte solution 2504 across the surfaces of the electrodes 2506, 2508, thereby assisting in the removal of gas bubbles and reaction byproducts that may otherwise accumulate and reduce electrolysis efficiency.

The pump 2502 may be implemented using various types of mechanisms, including, but not limited to, a bladed impeller or propeller attached to a motor, an induction stirrer that uses magnetic coupling to spin a mixing element, or a vibrating component such as an ultrasonic agitator that creates localized agitation within the liquid. In some embodiments, a mechanical flap or lever actuated by user interaction, such as opening the lid or dispensing a wipe, may serve as a passive or semi-passive circulation mechanism.

Circulation of the electrolyte solution 2504 enhances the electrochemical process by increasing mass transport near the electrodes 2506, 2508, and preventing the formation of stagnant zones. This results in a more consistent chemical environment, reduces the impedance caused by gas buildup, and improves the overall rate of HOCl generation. In certain configurations, the pump may operate continuously during electrolysis or be activated intermittently based on input from sensors monitoring solution conductivity, impedance, or other parameters. This embodiment is particularly useful in compact or sealed systems where natural convection may be insufficient to maintain uniform conditions within the fluid. The inclusion of the pump contributes to improved electrode performance, prolonged component life, and a more reliable and effective disinfecting solution.

FIG. 26 illustrates a perspective view of a wipe handling device 2600, in accordance with another embodiment of the present disclosure. In this embodiment, the wipe handling device 2600 includes a processor 2602, at least one user interaction detection sensor 2604, and a motor. The at least one user interaction detection sensor 2604 is mounted on at least one of a lid 2606 or a container 2608. The at least one user interaction detection sensor 2604 is communicably coupled to the processor 2602. The at least one user interaction detection sensor 2604 is configured to provide an output signal corresponding to the approach of a user. Further, the motor is provided with a drive shaft engaging with a rotational shaft of the lid 2606. The motor is communicably coupled to the processor 2602 to receive an input signal. The processor 2602 controls the motor to pivot the lid 2606 to the openable position 202 when the user approaches the wipe handling device 2600, and to the closable position 106 when the user departs from the wipe handling device 2600. The at least one user interaction detection sensor 2604 may include a distance or proximity sensor, which can include, but is not limited to, infrared (IR), ultrasonic, or acoustic wave detectors. In other embodiments, the at least one user interaction detection sensor 2604 may be implemented using alternative technologies such as audio detection, temperature sensing, ambient light sensing, or wireless communication-based sensors such as Wi-Fi or Bluetooth signal strength detectors.

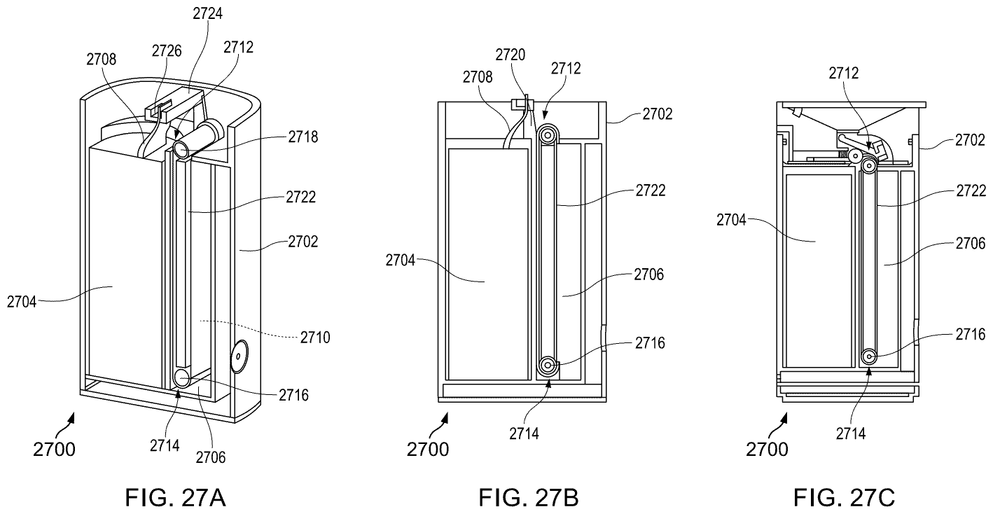

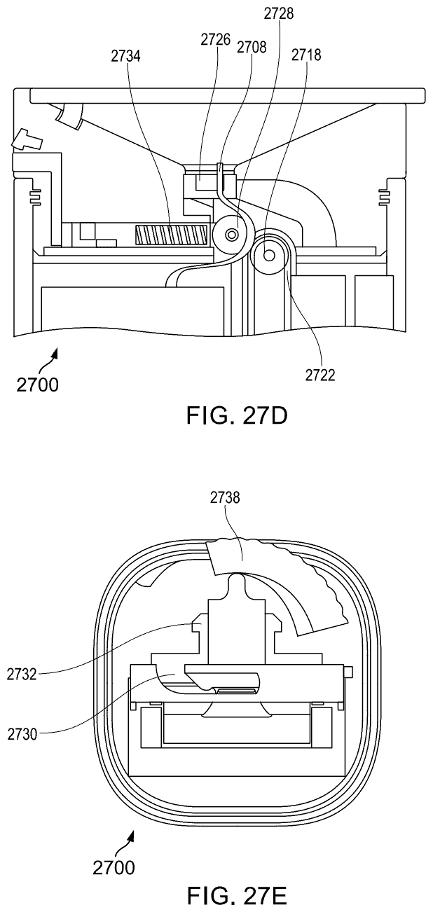

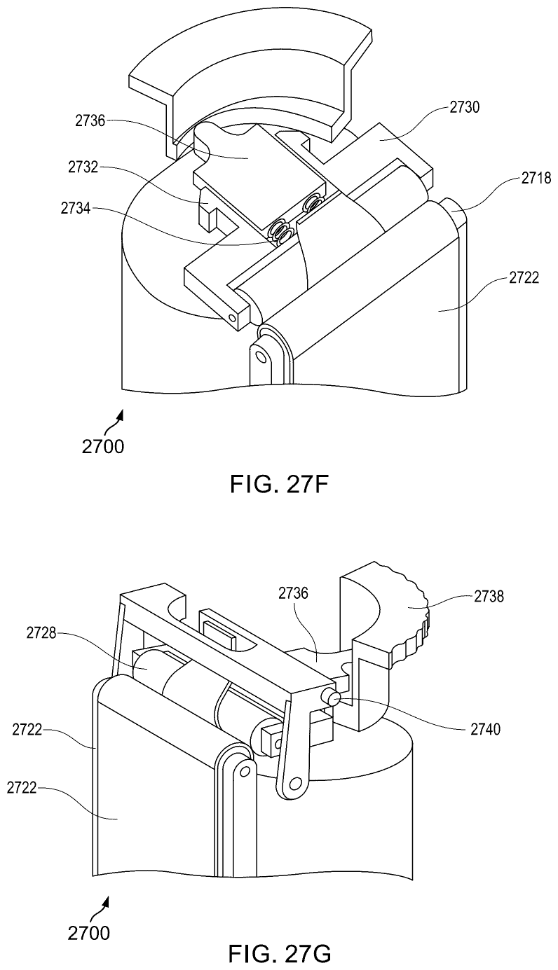

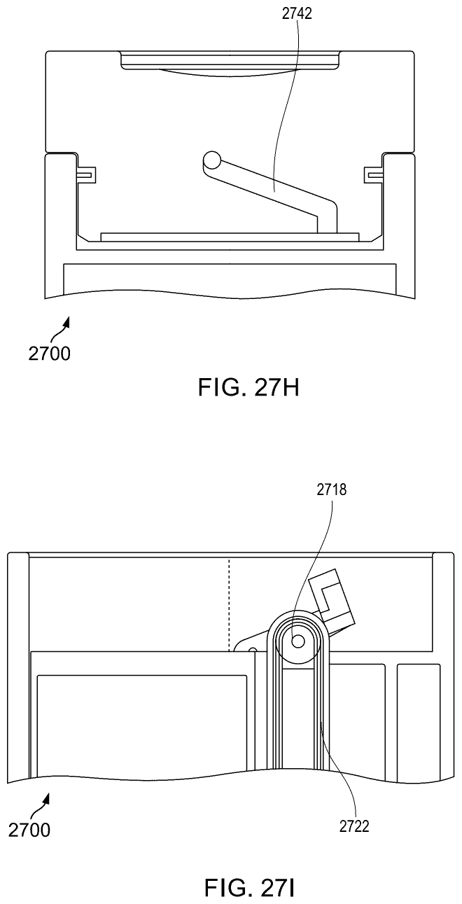

FIGS. 27A to 27I show a schematic representation of a wipe handling device 2700, in accordance with another embodiment of the present disclosure. Referring to FIGS. 27A, 27B, and 27C, the wipe handling device 2700 includes a container 2702 which includes one or more chambers 2704, 2706. The one or more chambers 2704, 2706 include a first chamber 2704 for accommodating at least one wipe 2708 and a second chamber 2706 for accommodating a wipe solution 2710. A wipe-infusing unit 2712, of the representative example, includes a belt drive assembly 2714 at least partially disposed within the second chamber 2706. The belt drive assembly 2714 includes a first roller 2716 positioned within the second chamber 2706, a second roller 2718 positioned at an outlet 2720 of the first chamber 2704 dispensing the wipe 2708, and a transmission belt 2722. The transmission belt 2722 is operably connecting the first roller 2716 to the second roller 2718. The transmission belt 2722 is configured to infuse the wipe solution 2710 into the wipe 2708 through movement of the transmission belt 2722.

In an embodiment, the container 2702 includes a guide fixture 2724 for the leading wipe 2708 that allows the user to position the leading wipe 2708 conveniently by placing the leading wipe through a channel 2726. The fixture 2724 is positioned above the wipe roll. The transmission belt 2722 is made from a material that can pick up and dispense liquid, either through absorption, perforations, texture, holes, or indents. The belt may be made from Cotton, Rayon, Bamboo Fiber, Microfiber, Chamois Leather, Spandex, Nylon, Polyamide, Polyester, Latex, Polyurethane, Polypropylene, Cotton, Rayon, Neoprene, or other materials. The belt moves with little or no slippage with the wipes as they come out of the device.

A circuit board with two or more rotation sensors is positioned near one or both rollers 2716, 2717 that feed the transmission belt 2722. Possible rotation sensors include: rotary encoders, optical encoders, Hall effect sensors, potentiometers, capacitive position sensors, or fiber optic sensors. In the case that a Hall effect sensor is used, a ferrous or magnetic material is embedded in the rollers and is detected by the Hall effect sensors to indicate the rollers'angular position. One roller may be slightly larger than the other in diameter (i.e., 6.00 mm and 6.05 mm), so that the angular positions together can be used to indicate how much distance has been traversed by a wipe chain that feeds over the rollers over a large distance, storing the data for how many wipes have been used from the container. Encoders or other methods of measuring the absolute angle of rotation could be used to track the roller turns in other embodiments. Other methods of tracking the amount of wipes used may also be used in other embodiments, such as distance sensors, proximity sensors, time of flight sensors, pressure sensors, force sensors, photoelectric sensors, electrical conductivity, touch sensors, ultrasound sensors, and other sensing mechanisms.

Referring now to FIGS. 27D, 27E, 27F, and 27G, the wipe-infusing unit 2712 further includes a third roller 2728. Without limitation, the third roller 2728 could also be a static piece of material. The third roller 2728 is configured to contact at least a portion of the transmission belt 2722 wrapping the second roller 2718. The wipe 2708 is movably positioned between the third roller 2728 and the portion of the transmission belt 2722. The wipe-infusing unit 2712 further includes a slider member 2730. The slider member 2730 is operatively connected to the third roller 2728. The slider member 2730 includes stopper elements 2732 configured to limit the movement of the slider member 2730 beyond a predefined threshold. The wipe-infusing unit 2712 further includes one or more resilient members 2734 positioned to abut the third roller 2728. The one or more resilient members 2734 are configured to apply a force against the third roller 2728 to create a compressive force on the wipe 2708.

A cam 2736 of the wipe-infusing unit 2712 is mounted between the stopper elements 2732. The cam 2736 is configured to contact the one or more resilient members 2734. The slidable motion of the cam 2736 is configured to adjust the compressive force applied to the one or more resilient members 2734. In at least some embodiments, a user-operable adjustment actuator 2738 is operatively coupled to the cam 2736. The user-operable adjustment actuator 2738 is configured to allow the user to control the concentration of the wipe solution 2710 infused into the wipe 2708 by adjusting the compressive force applied to the wipe 2708. The user-operable adjustment actuator 2738 may have settings for high wetness, low wetness, and completely dry wipes. Dry wipes are achieved by the least amount of pressure being applied, in which the roller applies little or no force to the wipe. In other embodiments, this pressure-applying system may apply pressure to an already-wet wipe to adjust the wetness to a drier state. In some embodiments, as shown in FIGS. 27G and 27H, a pin 2740 and a slot 2742, which may be used to move the guide fixture 3900, as the container top is added to the wipe handling device 2700. Further, as shown in FIGS. 27D and 27I, the guide fixture 2724 in the downward state prior to the cam engaging (and the cover being added to the device), and then also the upward state after the cover has been added, in which the guide slots the wipe through the device top.

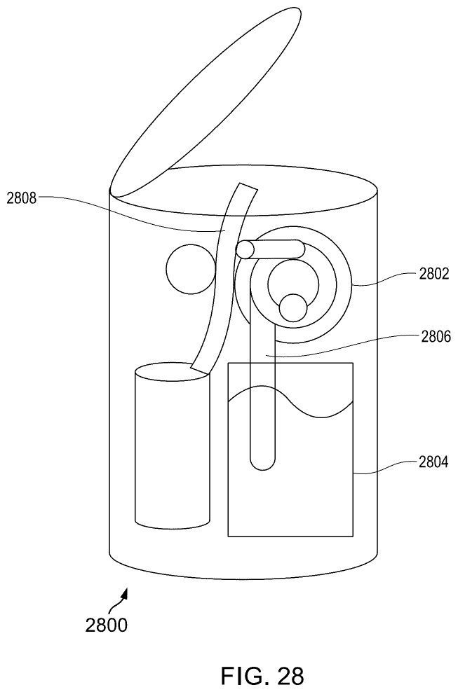

FIG. 28 illustrates a front view of a wipe handling device 2800, in accordance with another embodiment of the present disclosure, the wipe handling device 2800 includes a container 2802 which includes one or more chambers 2804, 2806. The one or more chambers 2804, 2806 include a first chamber 2804 for accommodating at least one wipe 2808 and a second chamber 2806 for accommodating a wipe solution 2810. A wipe-infusing unit 2812 includes a primary roller 2814 disposed above the first chamber 2804, a secondary roller 2816 positioned in contact with the primary roller 2814, and a pump 2818 fluidically connected to the second chamber 2806 and configured to infuse the wipe solution 2810 into the wipe 2808. The wipe 2808 is positioned to pass between the primary roller 2814 and the secondary roller 2816. The pump is operably coupled to and mechanically driven by the secondary roller 2816. The pump 2818 may be driven optionally by the motion of opening or closing of the lid (e.g., the lid 104), a separate physical input from the user, such as a lever, or a suitable motor. The pump 2818 can be peristaltic, diaphragm, lobe, piston, rotary, electromagnetic, plunger, rope, or other designs.

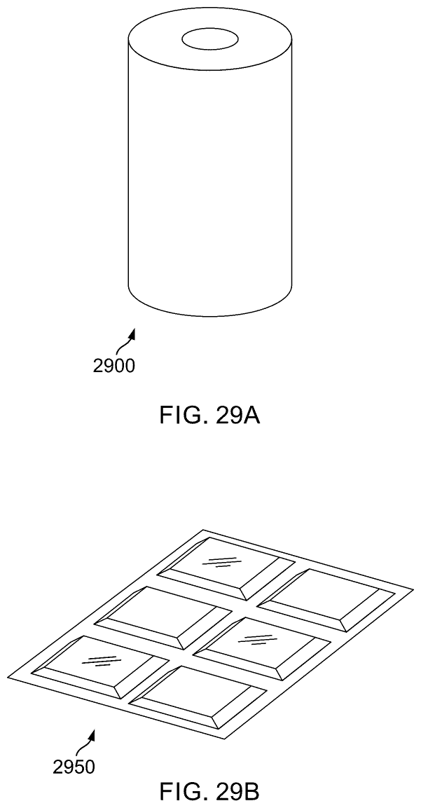

FIG. 29A illustrates a perspective view of a wipe roll 2900, in accordance with at least some embodiments of the present disclosure. FIG. 29B illustrates a perspective view of one or more activator capsules 2950, in accordance with at least some embodiments of the present disclosure. The wipe roll 2900 may be fabricated from a variety of materials, including, but not limited to, viscose, bamboo, synthetic polymers, biodegradable plastics, or composite materials, and may be provided in either a dry or pre-moistened state.

The activator capsule 2950, which contains a mixture of active and auxiliary ingredients, is designed to chemically activate and/or enhance the wipes. In representative embodiments, the formulation of the activator capsule 2950 may include one or more of the following: salt, acetic acid, citric acid, vinegar, fragrances, water, HOCl, and/or HOCl-generating compounds such as sodium dichloroisocyanurate (NaDCC). Other additives may also be included to improve wipe properties, such as cleaning efficacy, aroma, tactile feel, visual appearance, color, or surface texture.

The wipe handling device may 100 utilize the wipes that are pre-treated or infused with various chemical agents to enhance performance. In some embodiments, the wipe (e.g., the wipe 316) may be pre-treated with at least one agent, such as citric acid or a barrier agent, to provide specific functional benefits, including pH modification or improved stability. The wipe solution used in the wipe handling device 100 may include a combination of substances, including salts, citric acid, water, and other suitable pH buffering agents. To broaden applicability and avoid limiting the composition, the pH-modifying component is not restricted to citric acid alone but may include a range of acids such as acetic acid (vinegar), phosphoric acid, dilute hydrochloric acid, dilute sulfuric acid, lactic acid, malic acid, ascorbic acid, and other equivalents capable of adjusting the pH of the solution. These substances collectively contribute to maintaining the desired chemical balance and efficacy of the solution infused into the wipe.

The activator solution contained within the activator capsule 2950 may be in powder, liquid, gel, or solid form, and is designed to dissolve upon contact with water or other liquids present in the container. Upon dissolution, the capsule contents participate in a chemical or electrochemical reaction to generate a disinfecting or cleaning solution, such as HOCl, which is subsequently used to infuse the wipes stored within the container. In some embodiments, the activator capsule 2950 is designed to be fully dissolvable, thereby simplifying the activation process and eliminating the need for post-use removal. The combination of the capsule contents with water inside the container serves as the precursor mixture for on-demand generation of the active disinfectant solution. In another embodiment, the activator capsule 2950 is pre-filled with a composition including HOCl along with one or more additional precursor ingredients necessary for the in-situ regeneration or stabilization of HOCl. Such ingredients may include, but are not limited to, sodium chloride (salt), water, pH buffering agents, and HOCl-generating compounds, such as sodium dichloroisocyanurate (NaDCC), among other functional additives.

In this configuration, the activator capsule 2950 is adapted to be introduced into the wipe handling device 100, wherein it may optionally be combined with water. The primary advantage of this embodiment lies in its capability to deliver immediate usability: once the capsule and wipe roll are loaded into the device, the system is operational and ready to dispense disinfectant-infused wipes without necessitating an electrolysis cycle to produce HOCl.

As a result, the infused wipes become available for use almost instantaneously, either immediately or within a short delay of several seconds, thereby improving the user experience during initial use. Furthermore, the device may optionally include an integrated electrolysis module or other HOCl regeneration mechanism configured to replenish or restore the concentration of the HOCl solution over time, particularly as the disinfecting efficacy diminishes due to natural degradation. This hybrid approach allows for fast activation at the point of first use, combined with extended operational lifespan through on-demand in-device regeneration, without requiring additional user intervention.

In yet another embodiment, the wipes may be pre-treated or pre-infused with one or more chemical agents, including but not limited to: precursors for in-situ chemical reactions, fragrance compounds, colorants, and other functional additives. The purpose of such pre-treatment is to enable or enhance the generation of disinfectant or cleaning solutions, such as the HOCl solution, during or after interaction with a liquid medium. For instance, the wipe roll may be pre-treated with sodium chloride (salt), acetic acid, vinegar, citric acid, HOCl solution, pH buffering agents, aromatic compounds, and/or other reactive or enhancing substances. The wipes may be in a dry, partially moist, or fully wet state at the time of packaging.

In an alternate implementation, the wipe roll 2900 may be integrally attached to or packaged with a dissolvable activator capsule 2950 including any of the aforementioned ingredients, including but not limited to salt, acetic acid, vinegar, citric acid, HOCl, HOCl precursors (e.g., sodium dichloroisocyanurate), acidic pH buffers, fragrances, and other compounds formulated to chemically react with water or other liquid carriers introduced into the device. Upon dissolution, the contents of the capsule may activate, infuse, or chemically modify the wipes to enhance their antimicrobial efficacy, sensory properties, or visual characteristics (e.g., color).

The activator capsule 2950 may be water-soluble or disintegrable upon exposure to moisture, allowing seamless integration into the internal environment of the wipe handling device 100 and ensuring controlled release of its contents into the solution chamber or directly onto the wipes. In certain embodiments, fragrances may be incorporated into or applied to the wipe rolls to enhance user experience and provide functional cues regarding the intended application of the wipes. The fragrance formulations may vary based on the intended use case, such as, but not limited to, general cleaning, disinfecting, pet care, personal hygiene, body cleansing, or other specialized or therapeutic applications. The fragrance may be pre-infused into the material of the wipes during manufacturing or may be applied post-production by a user, either directly to the wipes or via an associated fragrance-dispensing module or compartment integrated into the container. In some embodiments, the fragrance may be user-selectable or customizable, thereby allowing individuals to choose a preferred scent based on personal preference, sensitivity, or functional need. The fragrance delivery mechanism may employ microencapsulation, volatile oil impregnation, fragrance-releasing gels, fragrance capsules, or other suitable delivery technologies. In an alternate embodiment, the fragrance may be included in a dissolvable capsule (as described in previous embodiments), which releases aromatic compounds into the solution or onto the wipes upon activation with a liquid medium.

In various embodiments, color indicators may be employed in connection with the wipes to provide visual feedback to a user regarding the functionality and/or chemical activation status of the wipes. The color of the wipes may be configured to denote specific end-use applications, including but not limited to: surface cleaning, disinfection, pet care, personal hygiene, medical or sanitary use, or general body cleansing. Such color coding may assist users in quickly identifying the intended use of a particular wipe, thereby reducing the likelihood of misuse. In some embodiments, the color of the wipe material may be pre-determined during manufacturing. In other embodiments, the color may dynamically change based on chemical interaction with one or more components within the container. For example, the wipe may be initially uncolored or a first color upon introduction into the container, and may change to a second color as a result of exposure to a chemical reaction, such as the formation or infusion of the HOCl solution or other disinfecting agents. The color change may be responsive to specific chemical parameters, including, but not limited to: pH, oxidation-reduction potential, chlorine concentration, or presence of specific ions or molecules. This functionality may be achieved by pre-treating the wipes with colorimetric indicators, pH-sensitive dyes, or redox-sensitive compounds that provide a visually discernible change upon activation. Such a feature may enable users to determine whether a wipe has been properly activated and remains within its useful lifespan, thereby enhancing safety, effectiveness, and user confidence in the product.

In some embodiments, the wipes (e.g., the wipes 316) may include a feed-assist attachment configured to facilitate the initial threading or feeding of a first wipe through a dispensing path or outlet of the container (e.g., the container 102). The feed-assist attachment may be pre-attached to the leading edge of the wipe roll and may be configured to interact with one or more components of the dispensing mechanism, such as rollers, guides, or apertures, thereby ensuring proper alignment and reducing manual handling. In certain embodiments, the attachment may be disposable and designed to be detached and discarded by the user after successful feeding of the first wipe, thus maintaining cleanliness and operational efficiency.

Additionally, water or other liquid may be introduced into the container (e.g., the container 102) from standard household sources, such as faucets, sinks, showers, hoses, cups, pitchers, or similar implements. The container (e.g., the container 102) may include a designated fill port, opening, or inlet configured to facilitate easy user access for fluid addition. The added liquid may then interact with preloaded ingredients, such as those contained in capsules or pre-treated wipe material, to generate or enhance a chemical cleaning solution, for example, the HOCl solution, for infusion into the wipes. In various embodiments, the fill port may be configured with a cap, valve, or seal to prevent spillage, contamination, or evaporation following fluid addition.

Various embodiments of the disclosure, as discussed above, may be practiced with steps and/or operations in a different order, and/or with hardware elements in configurations which are different from those which are disclosed. Therefore, although the disclosure has been described based upon these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A wipe handling device, comprising:
a container comprising one or more chambers, the one or more chambers configured to accommodate at least one wipe and a wipe solution; and
a wipe-infusing unit operably coupled to the one or more chambers to receive the at least one wipe and the wipe solution, the wipe-infusing unit configured to infuse the wipe solution into the at least one wipe at a predetermined concentration, thereby forming at least one infused wipe.

2. A wipe handling device as claimed in claim 1, further comprising a lid pivotally coupled to the container, the lid configured to operate between an openable position and a closable position, wherein the openable position facilitates the dispensing of the at least one infused wipe and the closable position facilitates sealing of the container.

3. The wipe handling device as claimed in claim 1, wherein the one or more chambers comprise:
a first chamber configured to accommodate the at least one wipe; and
a second chamber spaced apart from the first chamber, the second container configured to accommodate the wipe solution.

4. The wipe handling device as claimed in claim 3, wherein the wipe-infusing unit comprises:
a passage positioned below a discharge port of the first chamber;
a plurality of channels defined from the passage towards a wipe dispensing opening of the container; and
a plurality of rolling elements disposed alongside at least one of the plurality of channels to guide the at least one wipe through the wipe solution and towards the wipe dispensing opening of the container.

5. The wipe handling device as claimed in claim 3, wherein the wipe-infusing unit further comprises:
a rolling member positioned in contact with one of the rolling elements, wherein the at least one wipe is movably positioned between the rolling member and one of the rolling elements;
a user-operable adjustment actuator operatively coupled to the rolling member, wherein the user-operable adjustment actuator facilitates a user to control the concentration of the wipe solution infused into the at least one wipe by adjusting a compressive force applied to the at least one wipe through the rolling member.

6. The wipe handling device as claimed in claim 3, wherein the wipe-infusing unit comprises a belt drive assembly at least partially disposed within the second chamber, the belt drive assembly comprising:
a first roller positioned within the second chamber;
a second roller positioned at an outlet of the first chamber; and
a transmission belt operably connecting the first roller to the second roller, the transmission belt configured to infuse the wipe solution into the at least one wipe through movement of the transmission belt.

7. The wipe handling device as claimed in claim 6, wherein the wipe-infusing unit further comprises:
a third roller configured to contact at least a portion of the transmission belt wrapping the second roller, wherein the at least one wipe is movably positioned between the third roller and at least the portion of the transmission belt;
a slider member operatively connected to the third roller, the slider member comprising stopper elements configured to limit the movement of the slider member beyond a predefined threshold;
one or more resilient members positioned to abut the third roller, the one or more resilient members configured to apply a force against the third roller to create a compressive force on the at least one wipe;
a cam mounted between the stopper elements, the cam configured to contact the one or more resilient members, wherein the slidable motion of the cam is configured to adjust the compressive force applied to the one or more resilient members; and
a user-operable adjustment actuator operatively coupled to the cam, the user-operable adjustment actuator configured to allow a user to control the concentration of the wipe solution infused into the at least one wipe by adjusting the compressive force applied to the at least one wipe.

8. The wipe handling device as claimed in claim 3, wherein the wipe-infusing unit comprises:
a primary roller disposed above the first chamber;
a secondary roller positioned in contact with the primary roller, wherein the at least one wipe is positioned to pass between the primary roller and the secondary roller; and
a pump fluidically connected to the second chamber and configured to infuse the wipe solution into the at least one wipe, the pump being operably coupled to and mechanically driven by the secondary roller.

9. The wipe handling device as claimed in claim 3, wherein the wipe-infusing unit comprises:
an infusion section configured to infuse the wipe solution into the at least one wipe, the infusion section comprising:
a first inlet for receiving the at least one wipe dispensed from the first chamber;
a second inlet for receiving the wipe solution from the second chamber; and
an outlet for delivering the at least one infused wipe; and
a pump fluidically connecting the second chamber to the infusion section, wherein the pump is configured to supply the wipe solution from the second chamber to the infusion section.

10. The wipe handling device as claimed in claim 3, wherein the wipe-infusing unit comprises:
one or more flaps operably coupled to a sidewall of the container, the one or more flaps extending radially inward from the sidewall and configured to at least swing and rotate relative to the sidewall, the one or more flaps further configured to guide the at least one wipe dispensed from the first chamber along a predefined path and to facilitate replacement of a wipe roll; and
at least one treatment section fluidically coupled to the second chamber, the at least one treatment section configured to receive the wipe solution, wherein the at least one treatment section is positioned along the predefined path to infuse the wipe solution into the at least one wipe.

11. The wipe handling device as claimed in claim 1, wherein the one or more chambers comprise a single chamber configured to accommodate the at least one wipe and the wipe solution.

12. The wipe handling device as claimed in claim 2, further comprising:
a processor;
at least one user interaction detection sensor mounted on at least one of the lid or the container, wherein the at least one user interaction detection sensor is communicably coupled to the processor, the at least one user interaction detection sensor configured to provide an output signal corresponding to the approach of a user; and
a motor comprising a drive shaft engaging with a rotational shaft of the lid, the motor communicably coupled to the processor to receive an input signal, wherein the processor controls the motor to operate the lid in the openable position when the user approaches the wipe handling device, and in the closable position when the user departs from the wipe handling device.

13. The wipe handling device as claimed in claim 2, wherein the closable position of the lid is configured to limit evaporation and leakage of the wipe solution from the container.

14. The wipe handling device as claimed in claim 2, wherein the lid is pivotally coupled to the container via a bimodal hinge mechanism, the bimodal hinge mechanism configured to:
generate a closing force to the lid when the lid is in proximity of the closable position; and
generate an opening force when the lid is lifted beyond a predefined critical angle.

15. The wipe handling device as claimed in claim 3, wherein the second chamber is configured with an electrolysis unit, and the electrolysis unit is configured to generate a hypochlorous acid (HOCl) solution.

16. The wipe handling device as claimed in claim 15, further comprising an electrical circuit system electrically coupled to the electrolysis unit, the electrical circuit system comprising:
a power source configured to supply electrical energy to the electrolysis unit;
a regulator electrically coupled to the power source, the regulator configured to control at least one of voltage, current, or power delivered to the electrolysis unit;
a current-limiting component electrically coupled to the regulator, the current-limiting component configured to restrict current supply to one or more electrodes of the electrolysis unit;
a current measurement device and a voltage measurement device, each configured to measure, respectively, current flowing to and voltage across the one or more electrodes;
a processor communicably coupled to at least one of the current measurement device and the voltage measurement device to receive data, wherein the processor adjusts output parameters thereof based on the received data; and
one or more sensors selected from the group consisting of: a pH sensor, a spectrometer, a temperature sensor, a light source with a light sensor, a hydrogen gas sensor, and a salinity sensor, wherein one or more sensors are configured to monitor a property of an electrolyte solution of the eletolysis unit and to provide sensor data to the processor, wherein the processor is further configured to control the regulator to apply electrical energy to the electrolyte solution until a predetermined amount of chemical product is formed.

17. The wipe handling device as claimed in claim 16, further comprising one or more switches electrically connected in series with an anode electrode and a cathode electrode of the electrolysis unit, the one or more switches configured to generate electrical pulses to the electrolyte solution.

18. The wipe handling device as claimed in claim 16, further comprising an H-bridge switching configuration electrically connected to the anode electrode and the cathode electrode, the H-bridge switching configuration configured to produce pulsed current and reverse the polarity of the anode electrode and the cathode electrode.

19. The wipe handling device as claimed in claim 16, wherein one or more electrodes of the electrolysis unit are offset relative to other electrodes of the electrolysis unit such that when the electrolyte solution level falls below a predetermined threshold, the one or more electrodes loses electrical contact with the electrolyte solution.

20. The wipe handling device of claim 16, further comprising one or more additional electrical contacts configured to be submerged in the electrolyte solution to facilitate measurement of a level of the wipe solution.

21. The wipe handling device of claim 16, wherein the one or more additional electrodes are oriented at an angle relative to the other electrodes to generate an additional electric field and induce fluid flow within the electrolyte solution.

22. The wipe handling device as claimed in any one of claims 1 to 21, wherein the wipe solution is formed using an activator capsule, the activator capsule comprising one or more precursor ingredients for an electrolysis reaction, pH stabilizers, salts, and fragrances, wherein the activator capsule is deposited into the one or more chambers to initiate the formation of the wipe solution.

23. The wipe handling device as claimed in any one of claims 1 to 21, wherein the at least one wipe is made of at least one of bamboo, viscose, and biodegradable material.

24. The wipe handling device as claimed in one of claims 1 to 21, wherein the at least one wipe is pre-treated with at least one of citric acid or a barrier agent.

25. The wipe handling device as claimed in any one of claims 1 to 21, wherein the wipe solution comprises at least one of salt, citric acid, and water.

26. The wipe handling device as claimed in any one of claims 1 to 21, wherein the wipe solution is a hypochlorous acid (HOCl) solution.
